(19) United States
(12) Patent Application Publication
(10) Pub. No.: US 2026/0321450 A1
(43) Pub. Date: Oct. 15, 2026

(54) RADIATION SHIELD INCLUDING A CANOPY SYSTEM

(71) Applicant: James A. Goldstein, Bloomfield Hills, MI (US)

(72) Inventor: James A. Goldstein, Bloomfield Hills, MI (US)

(21) Appl. No.: 19/179,431

(22) Filed: Apr. 15, 2025

(51) Int. Cl. G21F 3/00

(52) U.S. Cl. CPC G21F 3/00

(57) ABSTRACT

A radiation shield, the shield comprising: a first generally vertically oriented radiopaque panel positionable generally transversely across a subject on a procedure table, the first panel having a lower edge with a recess having a upper edge and side edges forming an opening for accommodating a portion of a subject's body; at least one radiopaque collapsible canopy system, around the top and sides of the recess, and deployable downwardly to block radiation in the space between the subject and the top and sides of the recess; and radiopaque flaps depending down from the lower edge of the first panel on either side of the recess for blocking radiation between the lower edge of the first panel and the top of the procedure table.

### FIELD

The present disclosure relates to radiation shields adapted to be disposed transversely across a subject supported by the surface of a procedure table to protect medical professionals working on one side of the shield from radiation being applied to the subject on the other side of the shield.

### BACKGROUND

This section provides background information related to the present disclosure which is not necessarily prior art.

Radiographic equipment (e.g., x-ray equipment) is used when performing a wide variety of medical procedures. Many procedures require medical personnel to be in direct contact with a subject, thereby preventing the personnel from being in a separate room and potentially exposing the medical personnel to radiation. This has conventionally required medical personnel to wear heavy lead aprons during the procedure to reduce their exposure to radiation. Recently, radiation shields have gained acceptance during procedures involving radiation to protect medical personnel from exposure to radiation.

### SUMMARY

This section provides a general summary of the disclosure and is not a comprehensive disclosure of its full scope or all of its features.

This disclosure describes embodiments of a radiation shield adapted to be disposed transversely across a subject supported on the surface of a procedure table to protect medical professionals working on one side of the shield from radiation being applied to the subject on the other side of the shield. According to one such embodiment the shield comprises a first radiopaque panel with a lower edge with a recess having an upper edge and side edges forming an opening for accommodating a portion of a subject's body, a radiopaque collapsible canopy system, and radiopaque flaps depending from the lower edge of the first panel.

Any of the embodiments of the shield may include an aperture closure device in the canopy system to block radiation, and in particular scattered radiation, from passing through the canopies to medical personnel behind the shield. An opening, which can be adjustable, allows for necessary access to the subject, for example to introduce and navigate a catheter or other medical device.

This disclosure also describes embodiments of a method for protecting an operator during a procedure in which radiation is applied to a subject on a procedure table. According to one such embodiment this method comprises positioning a radiation shield having a first radiopaque panel transversely across a procedure table and the subject between a radiation source and an operator. The operator can operate a radiopaque collapsible canopy system to block radiation in the space between the subject and the top and sides of the recess.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a side view of a first embodiment of a radiation shield according to the principles of this disclosure;

FIG. 2 is an elevation view of the radiation screen of the radiation shield of the first embodiment;

FIG. 3 is a perspective view of the bottom portion of the primary screen of the radiation screen of the first embodiment;

FIG. 4 is a perspective view of the radiation shield of the first embodiment, as it would be used during a procedure being conducted on a procedure table under radiologic imaging;

FIG. 5 is a perspective view, over the shoulder of a medical professional, of the radiation shield of the first embodiment, as it would be used during a procedure being conducted on a procedure table under radiologic imaging;

FIG. 6 is a perspective view, facing the medical professional, of the radiation shield of the first embodiment, as it would be used during a procedure being conducted on a procedure table under radiologic imaging;

FIG. 7 is a view showing a medical professional working under the canopy of the radiation shield of the first embodiment;

FIG. 8 is a view showing a medical professional working under the canopy of the radiation shield of the first embodiment;

FIG. 9 is a view showing a medical professional working under the canopy of the radiation shield of the first embodiment;

FIG. 10 is a view showing a medical professional working under the canopy of the radiation shield of the first embodiment;

FIG. 11 is a view from above of the radiation shield of the first embodiment, as it would be positioned during a procedure using a femoral artery approach;

FIG. 12 is a view from the side of the radiation shield of the first embodiment, as it would be used during a procedure to shield a medical professional working at the side of a subject during a procedure using a femoral artery approach;

FIG. 13 is a side view of the radiation shield of the first embodiment, as it would be used during a procedure to shield a medical professional working at the side of a subject during a procedure using a femoral artery approach;

FIG. 14 is a side view of the radiation shield of the first embodiment, as it would be used during a procedure to shield a medical professional working at the side of a subject during a procedure using a femoral artery approach;

FIG. 15 is a view of the radiation shield of the first embodiment adapted for use in a shoulder access procedure;

FIG. 16 is a view of the radiation screen of the radiation shield of the first embodiment adapted for use in a shoulder access procedure;

FIG. 17 is a view from behind the shield of the first embodiment adapted for use in a shoulder access procedure;

FIG. 18 is a rear view of the shield of the first embodiment adapted for use in a shoulder access procedure;

FIG. 19 is a front view of the shield of the first embodiment adapted for use in a shoulder access procedure;

FIG. 20 is a rear view of the shield of the first embodiment, showing an aperture closure in the canopy on the forward side of the shield;

FIG. 21 is a rear view of the shield of the first embodiment, showing an aperture closure in the canopy on the forward side of the shield, and the canopy on the rearward side of the shield partially deployed;

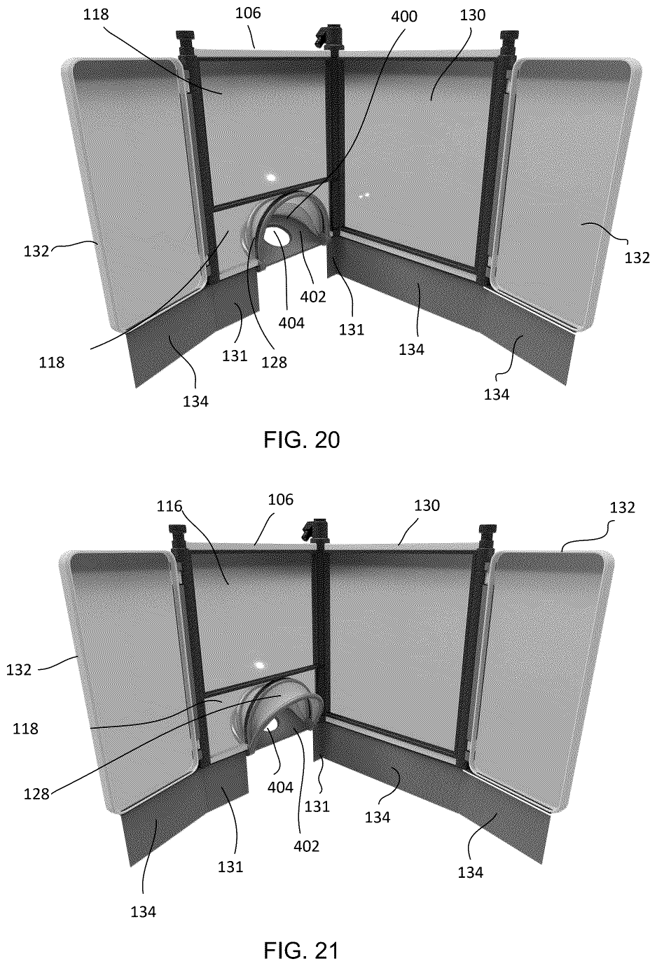

FIG. 20 is a rear view of the shield of the first embodiment, showing an aperture closure in the canopy on the forward side of the shield;

FIG. 22 is a front view of the shield of the first embodiment, showing an aperture closure in the canopy on the rearward side of the shield, and the canopy on the front side of the shield undeployed;

FIG. 23 is a front view of the shield of the first embodiment, showing an aperture closure in the canopy on the rearward side of the shield, and the canopy on the front side of the shield partially deployed;

FIG. 24 is a front view of the shield of the first embodiment, showing an aperture closure in the canopy on the rearward side of the shield, and the canopy on the front side of the shield fully deployed;

FIG. 25 is a rear view of the shield of the first embodiment, showing an aperture closure in the canopy on the rearward side of the shield, and the canopy on the rear side of the shield fully deployed;

FIG. 26 is a rear view of the shield of the first embodiment, showing an aperture closure in the canopy on the front side of the shield;

FIG. 27 is a rear view of the shield of the first embodiment, showing an aperture closure in the canopy on the front side of the shield, showing overlapping leaves partially closing the aperture;

FIG. 28 is a rear view of the shield of the first embodiment, showing an aperture closure in the canopy on the front side of the shield, showing overlapping leaves in the open position;

FIG. 29 is a rear view of the shield of the first embodiment, showing an aperture closure in the canopy on the front side of the shield, showing overlapping leaves in the open position;

FIG. 30 is a rear view of the shield of the first embodiment, showing an aperture closure in the canopy on the front side of the shield, showing overlapping leaves in the closed position;

FIG. 31 is a rear view of the shield of the first embodiment, showing an aperture closure in the canopy on the front side of the shield, showing overlapping leaves in an open position;

FIG. 32 is a rear view of the shield of the first embodiment, showing an aperture closure in the canopy on the front side of the shield, showing overlapping leaves in a closed position;

FIG. 33 is a rear view of the shield of the first embodiment, showing an aperture closure in the canopy on the front side of the shield, with the aperture open;

FIG. 34 is a rear view from above of the shield of the first embodiment, showing the possible adjustments of the secondary panel and wing panels;

FIG. 35, FIG. 36, FIG. 37, and FIG. 38 are a series of rear views from above of the shield of the first embodiment, showing the rotation of the radiation from a configuration for accessing the right side of the subject on the left side of the subject support (FIG. 35), to a configuration for accessing the left side of the subject on the right side of the subject support (FIG. 38);

FIG. 39 is a rear view from above of the shield of the first embodiment, showing a monitor mounted on the screen;

FIG. 40 is view of the front of the shield of the first embodiment, shown shielding a health care professional working on the right side of the subject on the left side of the subject support;

FIG. 41 is a view of the rear of the shield of the first embodiment, shown shielding a health care professional working on the right side of the subject on the left side of the subject support;

FIG. 42 is a view of the rear of the shield of the first embodiment, adapted for a shoulder access procedure;

FIG. 43 is a rear view of the shield of the first embodiment, showing providing shielding for a shoulder-access procedure;

FIG. 44 is a rear view of the shield of the first embodiment, showing providing shielding for a shoulder-access procedure;

FIG. 45 is a front view of the shield of the first embodiment, showing providing shielding for a shoulder-access procedure;

FIG. 46 is a rear view of the shield of the first embodiment, showing providing shielding for a shoulder-access procedure;

FIG. 47 is a front view of the shield of the first embodiment, showing providing shielding for a shoulder-access procedure;

FIG. 48 is a front view of the shield of the first embodiment, positioned for a shoulder-access procedure;

FIG. 49 is a rear view of the shield of the first embodiment, positioned for a shoulder-access procedure;

FIG. 50 is a rear view of the shield of a second embodiment of this disclosure, showing the main panel with an offset portion for accommodating movement of an imaging system C-arm;

FIG. 51 is a front view of the shield of a second embodiment of this disclosure, showing the main panel with an offset portion for accommodating movement of an imaging system C-arm;

FIG. 52 is a side view of the shield of a second embodiment of this disclosure, showing the main panel with an offset portion for accommodating movement of an imaging system C-arm;

FIG. 53 is a rear view of the shield according to the principles of this disclosure, with an integrated image display;

FIG. 54 is a rear view of a shield according to the principles of this disclosure, with an integrated image display;

FIG. 55 is a rear view of the shield of an alternate construction of a second embodiment of this disclosure, showing the main panel with an offset portion for accommodating movement of an imaging system C-arm.

FIG. 56 is a rear view of a shield according to the principles of this disclosure, with a curvilinear configuration incorporating an auxiliary panel and two wings;

FIG. 57 is a rear view of a shield according to the principles of this disclosure, with a curvilinear configuration incorporating two wings;

FIG. 58 is a perspective view of a third embodiment of a shield according to the principals of this disclosure;

FIG. 59 is a rear view of the screen of the shield of the third embodiment;

FIG. 60 is a rear view of the screen of the shield of the third embodiment;

FIG. 61 is a rear view of the screen of the shield of the third embodiment, showing how it provides access to a subject on a procedure table;

FIG. 62 is an elevation view of a companion shield, useful with the shields of this disclosure;

FIG. 63 is a view of the companion shield, shown as it would be positioned at the left side of a procedure table.

FIG. 64 is an elevation view of the companion shield, rotated about a vertical axis for use on the right side of a procedure table;

FIG. 65 is a view of the companion shield, shown as it would be positioned at the right side of procedure table;

FIG. 66 is a rear perspective view of the shield of the first embodiment being used during a medical procedure from the left side of a procedure table, with the companion shield deployed on the right side of the medical professional to substantially enclose the medical professional;

FIG. 67 is a front perspective view of the shield of the first embodiment being used during a medical procedure from the left side of a procedure table, with the companion shield deployed on the right side of the medical professional to substantially enclose the medical professional;

FIG. 68 is a rear perspective view of the shield of the first embodiment being used during a medical procedure from the left side of a procedure table, with the companion shield deployed on the right side of the medical professional to substantially enclose the medical professional;

FIG. 69 is an elevation view of an alternate construction of the companion shield, adapted to extend across the procedure table from the left side, useful with the shields of this disclosure;

FIG. 70 is an elevation view of the alternate construction of the companion shield, rotated about a vertical axis for use on the right side of a procedure table;

FIG. 71 is a rear perspective view of the shield of the first embodiment being used during a medical procedure from the right side of a procedure table, with the alternate construction of the companion shield deployed on the left side of the medical professional to substantially enclose the medical professional;

FIG. 72 is a front perspective view of the shield of the first embodiment being used during a medical procedure from the right side of a procedure table, with the alternate construction of the companion shield deployed on the left side of the medical professional to substantially enclose the medical professional;

FIG. 73 is a front perspective view of the shield of the first embodiment being used during a medical procedure from the right side of a procedure table, with the alternate construction of the companion shield deployed on the left side of the medical professional to substantially enclose the medical professional;

FIG. 74 is an elevation view of a second alternate construction of the companion shield, adapted to extend across the procedure table, useful with the shields of this disclosure;

FIG. 75 is an elevation view of a second alternate construction of the companion shield, adapted to extend across the procedure table, useful with the shields of this disclosure, shown as it would be deployed across a procedure table;

FIG. 76 is a front perspective view of the shield of the first embodiment being used during a medical procedure from the right side of a procedure table, with the second alternate construction of the companion shield deployed across the procedure table on the left side of the medical professional to substantially enclose the medical professional;

FIG. 77 is a front perspective view of an alternate construction of the shield, showing how the shield can be connected to the patient support so that the shield and patient support move together in procedure using a femoral artery approach; and

FIG. 78 is a front perspective view of an alternate construction of the shield, showing how the shield can be connected to the patient support so that the shield and patient support move together in procedure accessing the subject's shoulder or arm for example placing pacemaker, or using a radial artery approach.

Corresponding reference numerals indicate corresponding parts throughout the several views of the drawings.

### DETAILED DESCRIPTION

Example embodiments will now be described more fully with reference to the accompanying drawings.

As further described herein, a radiation shield can be positioned across a subject that is laying on a procedure table with a radiation source on one side of the radiation shield applying radiation to the subject. The radiation shield can be used to protect a medical professional working on the side of the shield opposite the radiation source.

A preferred embodiment of such a radiation shield includes a radiopaque panel positionable across the procedure table, the shield having an opening located at the lower edge of the panel to accommodate a portion of the subject's body passing through the shield, with a portion of the subject's body disposed on each side of the opening. A collapsible canopy system surrounds the opening and is deployable downwardly to block radiation in the space between the subject and the top and sides of the opening. As described in more detail below, an aperture closure device can be provided in or adjacent to the canopy m to block radiation, and in particular scattered radiation, from passing through the canopies to medical personnel behind the shield. An opening, which can be adjustable, allows for necessary access to the subject, for example to introduce and navigate a catheter or other medical device,

Radiopaque flaps can depend downwardly from the lower edge of the panel on either side of the opening to block radiation between the bottom edge of the panel and the procedure table.

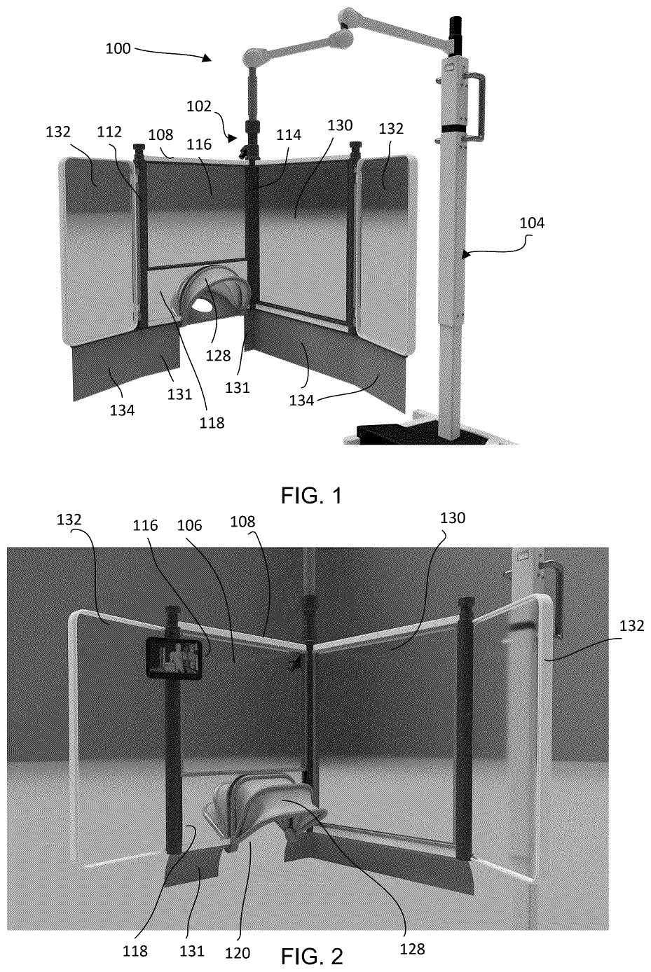

A first embodiment of a radiation shield according to the principles of this disclosure is indicated generally as 100 in the figures. As shown in FIG. 1, the radiation shield 100 comprises a radiation screen 102 and a radiation screen support 104.

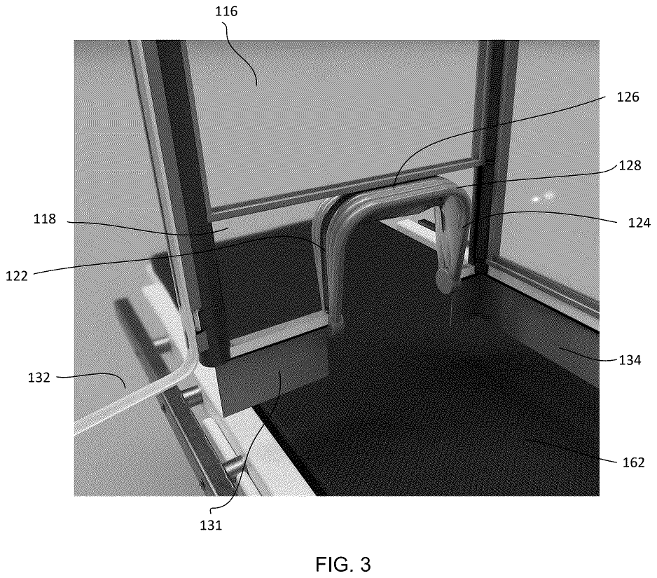

The radiation screen 102 comprises a primary panel 106, of a radiopaque material, having a top edge 108, a bottom edge 110, and left and right side edges 112, and 114. In this first embodiment the primary panel is formed of upper portion 116 and lower portion 118 having an upper portion 108 and a lower portion 110. The bottom edge 110 of the primary panel 106 has a recess 120, with left and right sides edges 122, 124, and a top edge 126 (FIG. 3), defining an opening for accommodating a portion of a subject's body, so that a portion of the subject's body can be disposed on one side of the primary panel 106, and a portion of the subject's body can be disposed on the other side of the primary panel.

At least one radiopaque collapsible canopy system, constructed of/with radiation resistant material (such as a lead-lined fabric 128 is disposed around the top edge 126 and sides 122, 124 of the recess 120, on at least one side of the primary panel 106. The canopy system 128 is deployable downwardly to block transmission of radiation in the space between the subject and the top and side edges 126, and 122, 124 of the recess 120. As described in more detail below, t the shield may include an aperture closure device in the canopy system to block radiation, and in particular scattered radiation, from passing through the canopies to medical personnel behind the shield. An opening, which can be adjustable, allows for necessary access to the subject, for example to introduce and navigate a catheter or other medical device. The adjustable device preferably can be controlled mechanically or electrically.

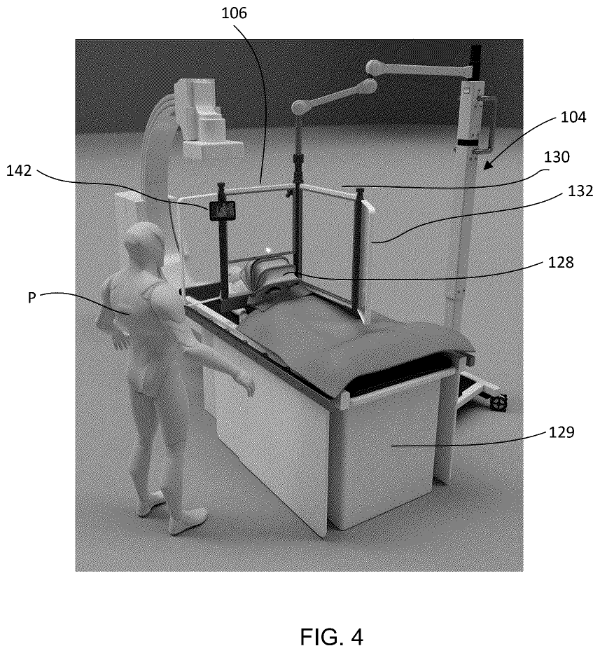

Radiopaque flaps 131 can depend downwardly from the bottom edge 110 of the primary panel 106, on either side of the recess 120 for blocking radiation from a radiation source 210 between the bottom edge of the primary panel 106 and the top of a procedure table (FIG. 4). These flaps, made of flexible radiation resistant fabric, may be constructed as a single panel or multiple overlapping sections.

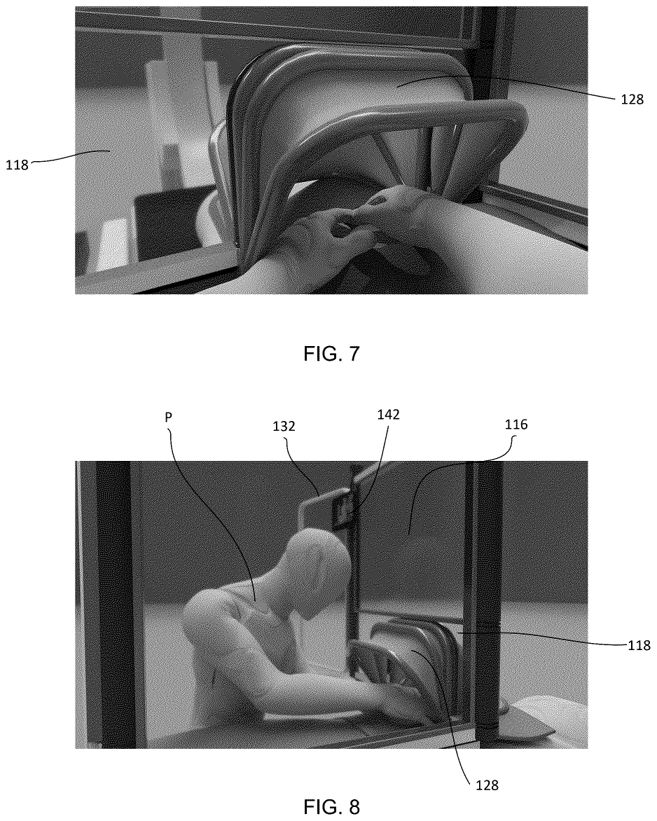

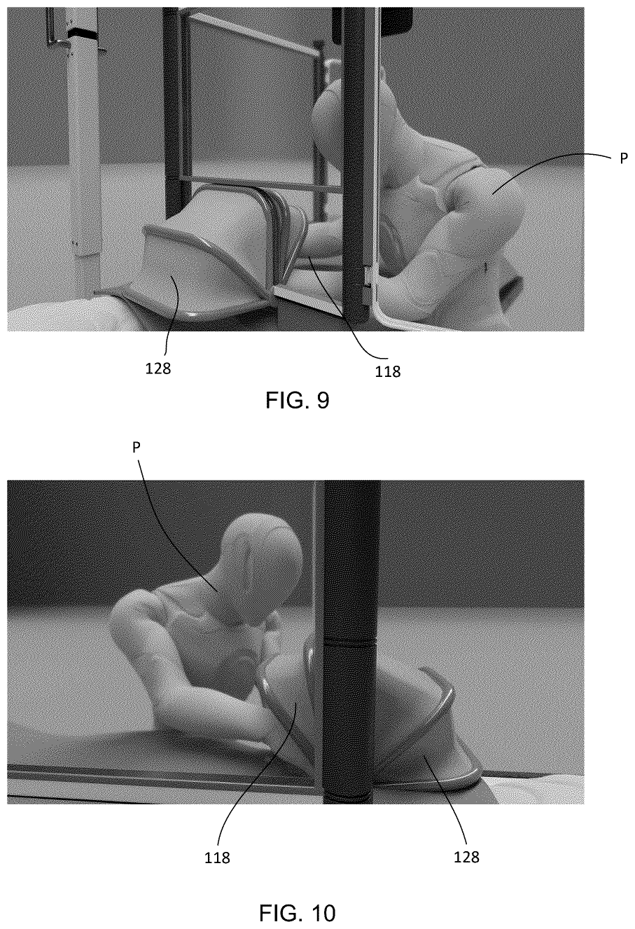

As shown for example in FIGS. 7-10, the canopy 128 can be formed by a plurality of inverted generally U-shaped frame members pivotally mounted about the free ends of the “U,” and covered by a flexible radiopaque web. The web can be pleated or have creases to facilitate deploying and retracting the canopy.

The canopy 128 creates a generally curved cover when expanded or deployed, and yet lies substantially flush to the primary panel 106 when retracted. While expanded, the canopy system 128 provides the medical professional a space in which to work (see FIGS. 7-10), while protecting others tending to the subject from the radiation (typically from x-ray imaging equipment) being applied to the subject on the other side of the screen 102. The canopy 128, when deployed, can reduce the radiation that might otherwise emanate through the recess 120 when radiation is being applied to a subject on the opposite side of the screen 102.

In some embodiments, as shown in FIGS. 2 and 3, a canopy 128 can be provided on each side of the primary panel 106. For example, the primary panel 106 has a forward face, generally facing the radiation source, such as x-ray imaging equipment mounted on a C-Arm, and a rearward face generally facing the healthcare professionals being shielded, with the canopy 128 coupled to the primary panel 106 on each face. The canopy 128 on the front face of the primary panel radiation from entering the opening 120, and the canopy on the rear face of the primary panel prevents radiation from exiting the opening.

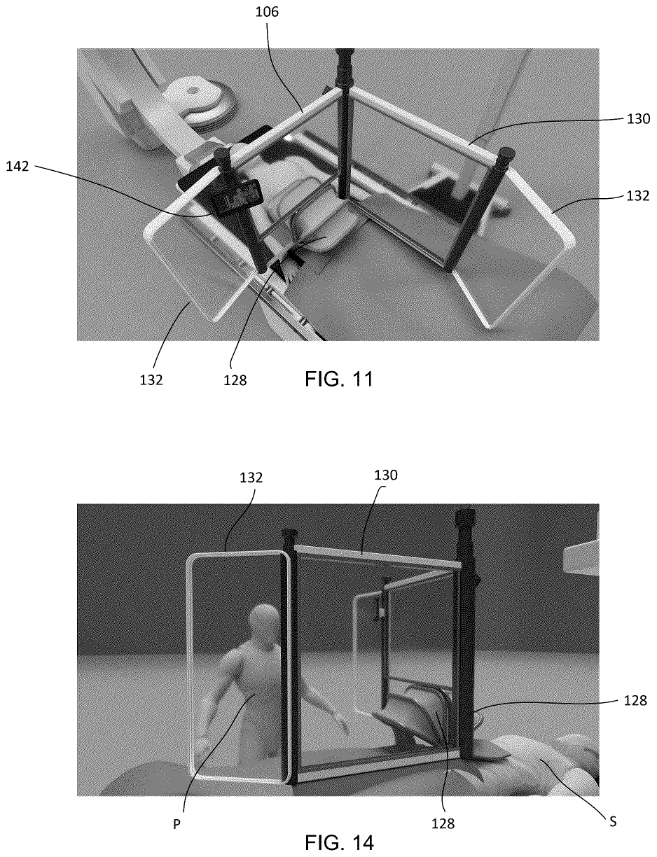

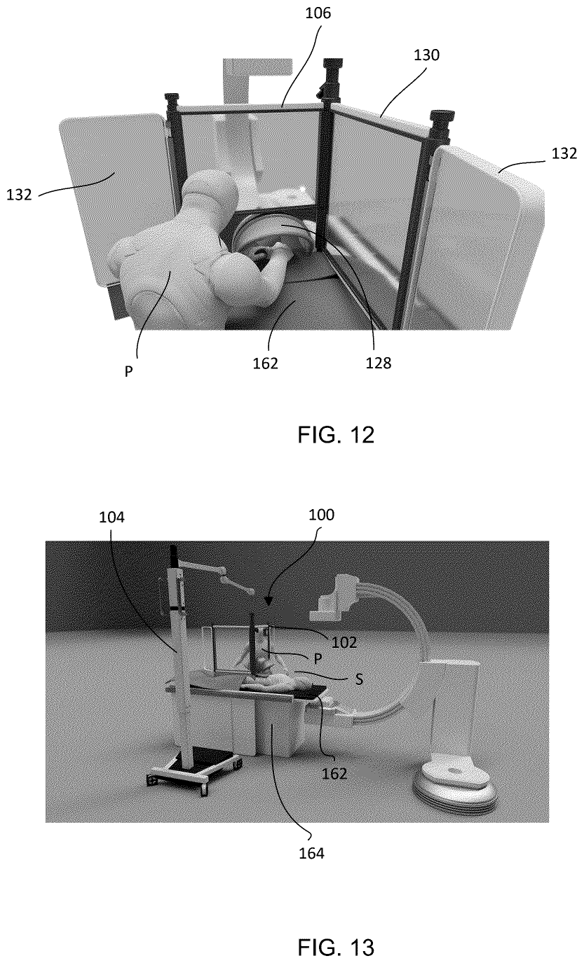

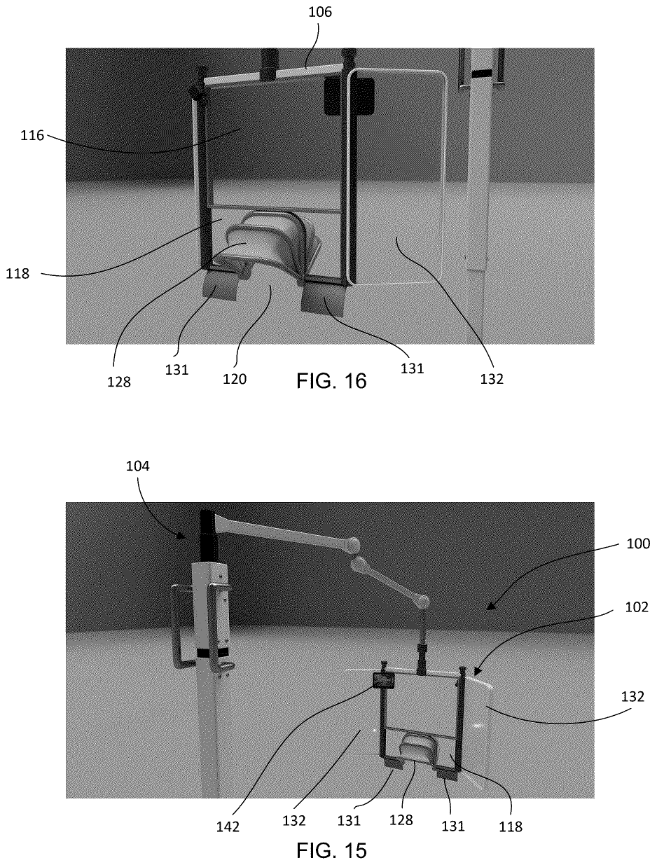

In the various embodiments of this disclosure, one or more radiopaque secondary panels 130 can be mounted to the primary panel 106 at one of its sided edges, for example right side edge 114. One such secondary panel 130 is shown in FIGS. 2, 4, 11-14. The secondary panels 130 can be fixedly attached to the primary panel 106. Alternatively, the secondary panels 130 can be pivotally mounted to the primary panel 106. The secondary panels 130 may be fully, or at least partially transparent.

In some embodiments, the secondary panel 130 is coupled to the primary panel 106 at the right side edge 114 when the procedure is being conducted on the left side of the procedure table adjacent the subject's right side, in other embodiments, the secondary panel 130 is coupled to the primary panel 106 on the left side edge 112 when the procedure is being conducted on the right side of the procedure table, adjacent the subject's left side. In some embodiments (FIGS. 35-38) the primary panel 106 can be rotated 180° about a vertical axis so that the secondary panel 130 can effectively be moved from the right side of the primary panel 106 (FIG. 35) to the left side (FIG. 38), and vice versa, simply by rotating the primary panel 106.

In any of the various embodiments of this disclosure, radiopaque wing panels 132 can be mounted at the side edges of the primary panel 106 and/or of the secondary panels 130. Generally, the wing panels 132 can be constructed to be width-wise expandable, for example comprising an expandable frame with either a plurality of relatively telescoping sections, or a pleated expandable panel. The wings 132 are preferably pivotally mounted to their respective primary panel 106 or secondary panel 130 to be adjustable to swing as necessary to block radiation.

In any of the various embodiments of this disclosure, the secondary panels 130 and the wing panels 132 can include radiopaque flaps 134 depending from their lower edges to block radiation from between the bottom edge and the surface of the subject support. The flaps 134 can be integral to flaps 131 on the primary panel 106, all being part of a single continuous flap extending across multiple panels, or there can be a separate flap for each panel that are releasably jointed together, or there can be a separate flap for each panel that extend past the edges of their respective panels to overlap.

The radiation shield 100 can include at least one camera 140 positioned on the same side of the primary panel 106 as the radiation source, i.e., on the opposite side of the screen 102 from where the medical personnel are located. In some embodiments, the camera 140 is mounted adjacent to the primary panel at one of the hinged connections between the primary panel and a secondary panel 130 or wing panel 132. The camera 140 may be positioned such that the camera captures images of the portions of the subject's body on the side of the screen 102 opposite the medical personal, and provide visualization of these portions of the subject (e.g., the head or other parts of interest of the subject), without exposing the medical personal to radiation from the radiation source. The camera is mounted on a pivot that can be switched from one side of the panel to the other, to accommodate its use when the shield is rotated from one side of the patient to the opposite side.

In embodiments of shields employing cameras, the shield can also include one or more video monitors 142, which can be mounted on the primary panel 106 for displaying the output from the cameras 140. The video monitors 142 can be positioned on the side of the primary panel 106 opposite from the radiation source allowing the medical professional to visually monitor the subject by viewing the video monitors 142 without exposure to radiation. In some embodiments, the radiation shield can include a plurality of video monitors 140. I some embodiments the video monitors 142 can be integrated into the panels of the screen, as shown in FIGS. 53 and 54. The video monitor can be mounted on a pivot that can be switched from one side of the panel to the other, to accommodate its use when the shield is rotated from one side of the patient to the opposite side.

A radiation screen support 104 is adapted to support the radiation screen 102 over the surface 162 of a procedure table 164. The radiation screen support 104 comprises a wheeled bogie 150, a telescoping column 152 mounted on the wheeled bogey. An articulated arm 154, comprising first, second, and third segments 156, 158, and 160 is mounted on the telescoping column 152. The radiation screen 102 is mounted on the end of the third segment 160 of the articulated arm 154.

A radiation screen support 104 suspends the radiation screen 102 over the surface 160 of a procedure table 162. The procedure table 162 can have a plurality of radiopaque panels 164 along its length. The panels 164 can be slidably mounted to telescope to shield the base of the procedure table along its length.

A second embodiment of a shield is indicated generally as 200 in FIGS. 50-52. The shield 200 comprises a radiation screen 202 and a radiation screen support 104.

The radiation screen 202 comprises a primary panel 206, of a radiopaque material, comprising a generally vertical lower portion 208, a slopped intermediate portion 210, and a generally vertical upper portion 212, offset from the lower portion. Left and right side panels 214, 216 are disposed on either side of the upper portion 212, the lower edges of the side panels engage the sides of the intermediate portion 210.

As shown in FIGS. 50-52, the left and right side panels 214 and 216 are pleated to expand and contract so that the upper portion 212 can be moved relative to lower portion 208 to accommodate the movement of radiographic imaging equipment on a C-arm. The sloped intermediate portion can also be pleated, or comprise telescoping sections, to accommodate the movement of the upper portion. This component can be moved in either direction so that when the shield is pivoted to provide protection from one side of the patient to the opposite side, the tilt window can function in either direction to accommodate C-arm motions.

However as shown in FIG. 55, an alternate construction of the screen, indicated generally as 202′ can have rigid sidewalls 214 and 216, and intermediate portion 210, providing a fixed space for accommodating imaging equipment, or other radiation generating equipment.

The bottom edge of the lower portion 208 has a recess 220, with left and right sides edges 222, 224, and a top edge 226, defining an opening for accommodating a portion of a subject's body, so that a portion of the subject's body can be disposed on one side of the primary panel 206, and a portion of the subject's body can be disposed on the other side of the primary panel.

At least one radiopaque collapsible canopy system 228 is disposed around the top edge 226 and sides 222, 224 of the recess 220, on at least one side of the primary panel 206. The canopy system 228 is deployable downwardly to block transmission of radiation in the space between the subject and the top and side edges 226, and 222, 224 of the recess 220. Radiopaque flaps 230 can depend downwardly from the bottom edge of the primary panel 206, on either side of the recess 220 for blocking radiation from a radiation source between the bottom edge of the lower member 208 and the top of a procedure table.

The canopy 228 can be formed by a plurality of inverted generally U-shaped frame members pivotally mounted about the free ends of the “U,” and covered by a flexible radiopaque material. The canopy 228 can have a pleated configuration to facilitate deploying and retracting the canopy.

In some embodiments, the canopy system 128 can create a dome shape when expanded and be substantially flush to the primary panel 206 when retracted. While expanded, the canopy system 228 provides the medical professional protection when working on the subject adjacent the recess 220. The canopy system 228 can reduce the radiation that might otherwise emanate through the recess 220 at times when the primary panel 206 is positioned over the subject.

In some embodiments, a canopy system 228 can be provided on each side of the primary panel 206. For example, the primary panel 206 may have a forward face, generally face the radiation equipment, and a rearward face generally facing the healthcare professionals being shielded, with the canopy system 228 coupled to each face of the primary panel 206. The canopy 228 on the front face prevents radiation from entering the opening 220, and the canopy on the rear face prevents radiation from exiting the opening.

In the second embodiment, as in the first embodiment, one or more radiopaque secondary panels 130 can be mounted to the primary panel 206 at one of its sided edges. The secondary panels 130 can be rigidly attached to the primary panel 206, and preferably extends perpendicularly therefrom. Alternatively, the secondary panels 130 can be pivotally mounted to the primary panel 206. The secondary panels 130 may be fully, or at least partially transparent.

In some embodiments, the secondary panel 130 is coupled to the primary panel 206 at the right side edge when the procedure is being conducted adjacent the subject's right side, in other embodiments, the secondary panel is coupled to the primary panel on the left side edge when the procedure is being conducted on the subject's left side.

In various embodiments, radiopaque wing panels 132 can be mounted at the side edges of the primary panel 106 or of the secondary panels 130. Generally, the wings 132 can be constructed to be width-wise expandable, for example comprising an expandable frame with a plurality of telescoping sections, or a pleated expandable panel. The wings 132 are preferably pivotally mounted to their respective primary panel 106 or secondary panel 130 to be adjustable to protect the health care workers from radiation.

In some embodiments, the secondary panels 130 and the wing panels 132 can include a flap 134 depending from their lower edges to block radiation from between the bottom edge and the surface of the subject support. The flaps 134 can be integral with the flaps 231 on the primary panel 206, or they can be separate flaps joined together, or they can be separate flaps with overlapping margins.

FIGS. 56-57 show alternate constructions of embodiments of this disclosure in which the panels are curved. In particular FIG. 56 shows a primary panel 106′, a secondary panel 130′, and wing panels 132′ all formed in a curved configuration. Similarly, FIG. 57 shows a primary panel 106′ and wing panels 132′ all formed in a curved configuration.

A third embodiment of a shield according to the principles of this disclosure is indicated generally as 300 in FIGS. 58-61. The shield 300 comprises a screen 302, similar to screen 106 described above, and wing panels 332, similar to wing panels 132 described above. The primary panel 306 comprises an upper portion 316 and a lower portion 318. The lower edge 318 of the primary panel 306 has a recess for receiving a portion of a subject's body. A canopy 328, similar to canopy 128 described above is mounted over the recess to block radiation. There is a lower primary panel 306A, below the primary panel 306, and lower wing panels 132A below the wing panels 132.

An alternate construction of shield 300 is shown in FIGS. 60 and 61. In this alternate construction, screen 302′ comprises a primary panel 306′ that is similar to panel 306 described above but is curved in the horizontal or lateral direction. The lower panel 306A′ is similarly curved, as are wing panels 132 and 132A, so that the entire screen 302′ has a curved configuration.

Any of the embodiments described above may include an aperture closure device 400 in one of the canopies (128, 228, or 328), or between two canopies on opposite sides of the central panel (106, 206, or 306). The aperture closure device 400 comprises a radiopaque panel 402 with an opening 404, to block radiation, and in particular scattered radiation, from passing through the canopies to medical personnel behind the shield. The opening 404 allows for necessary access to the subject, for example to introduce and navigate a catheter or other medical device.

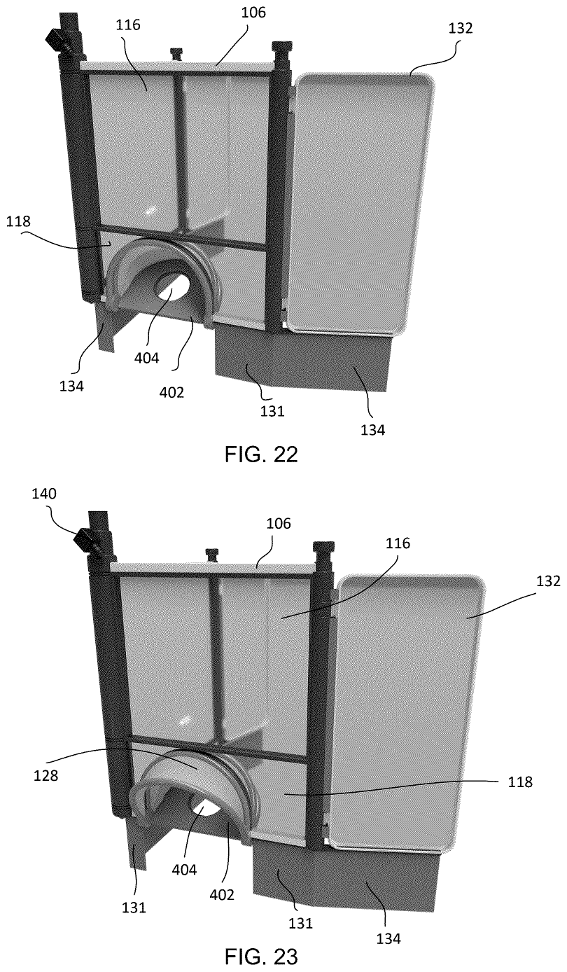

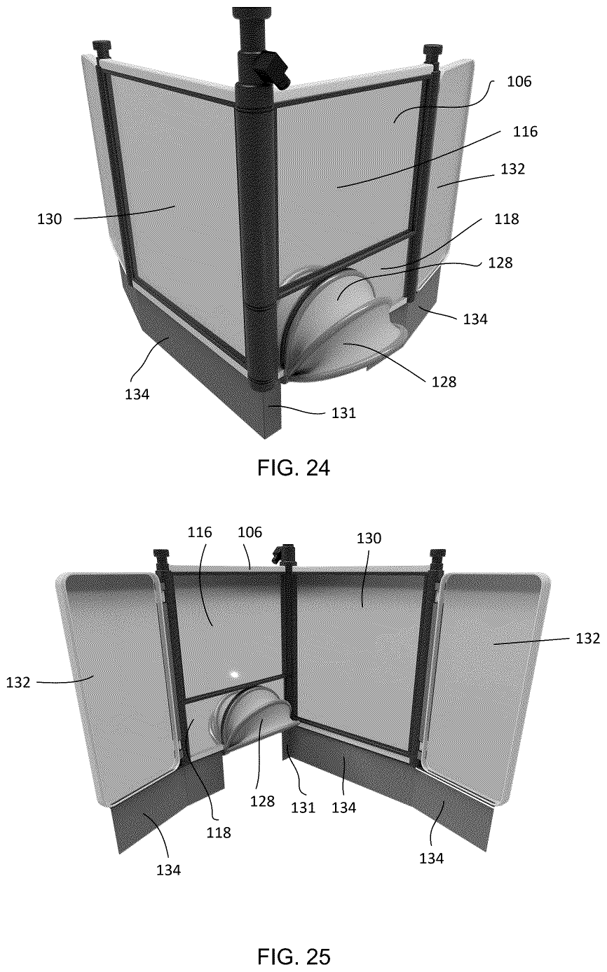

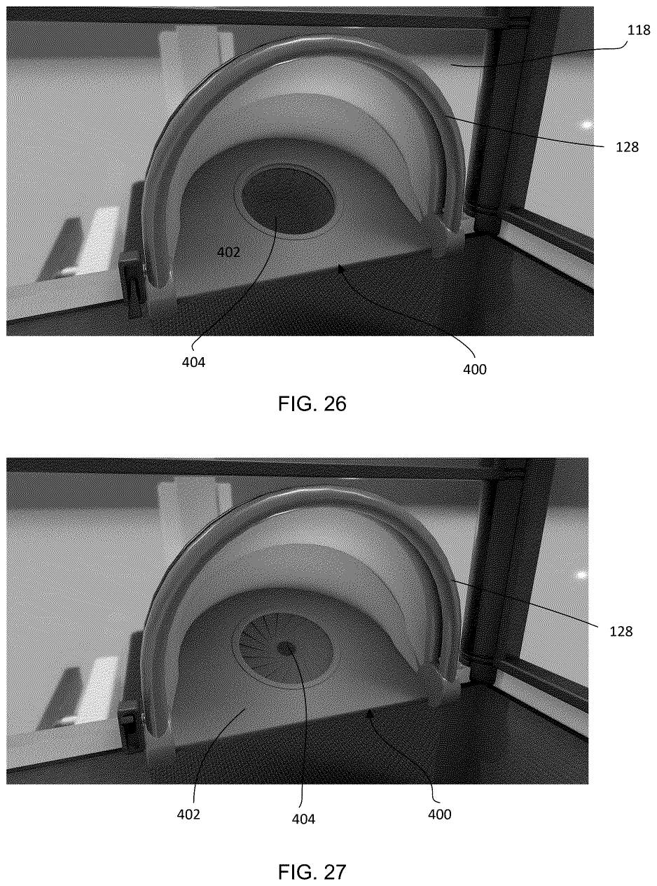

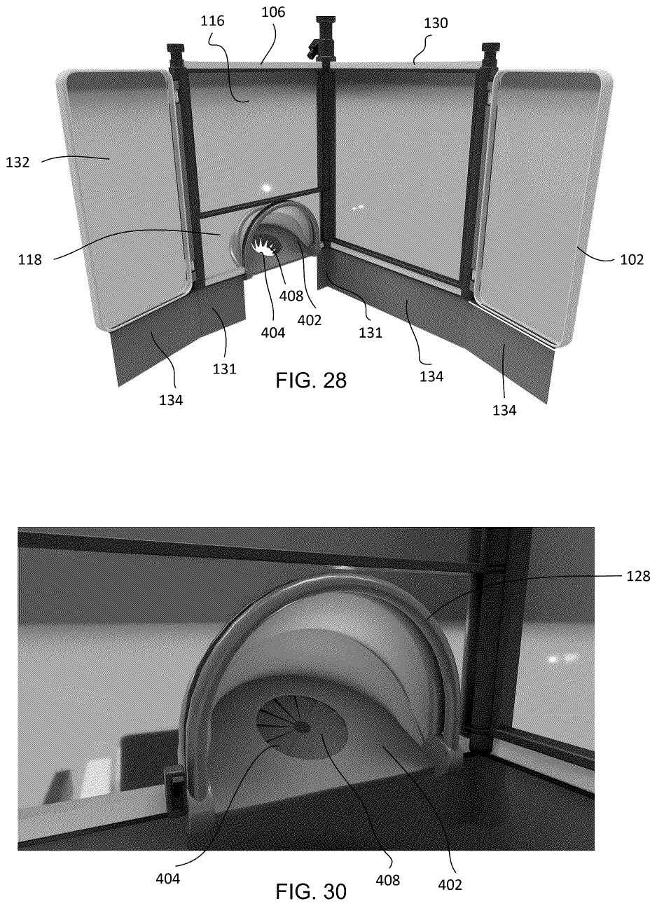

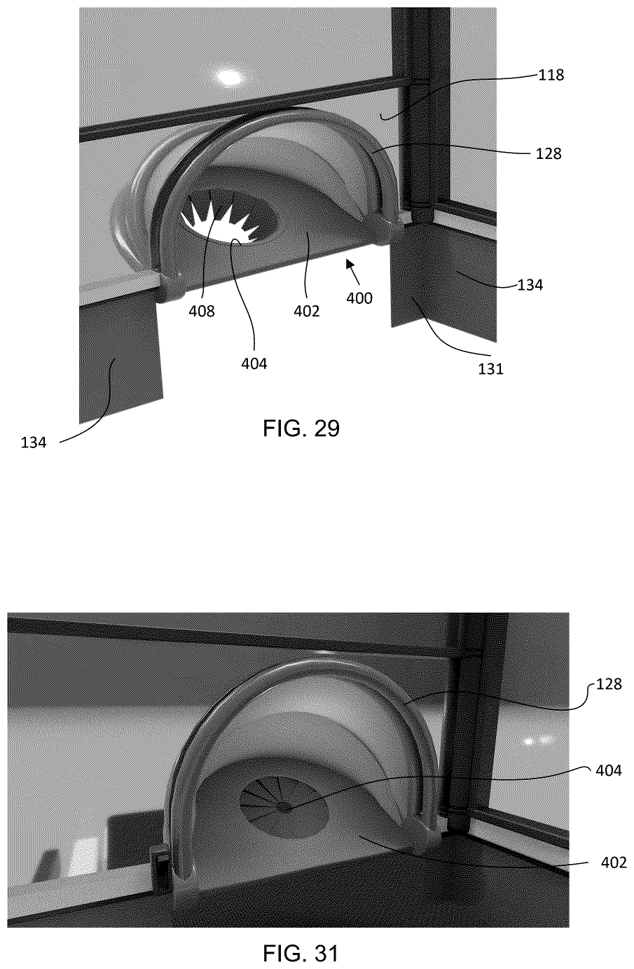

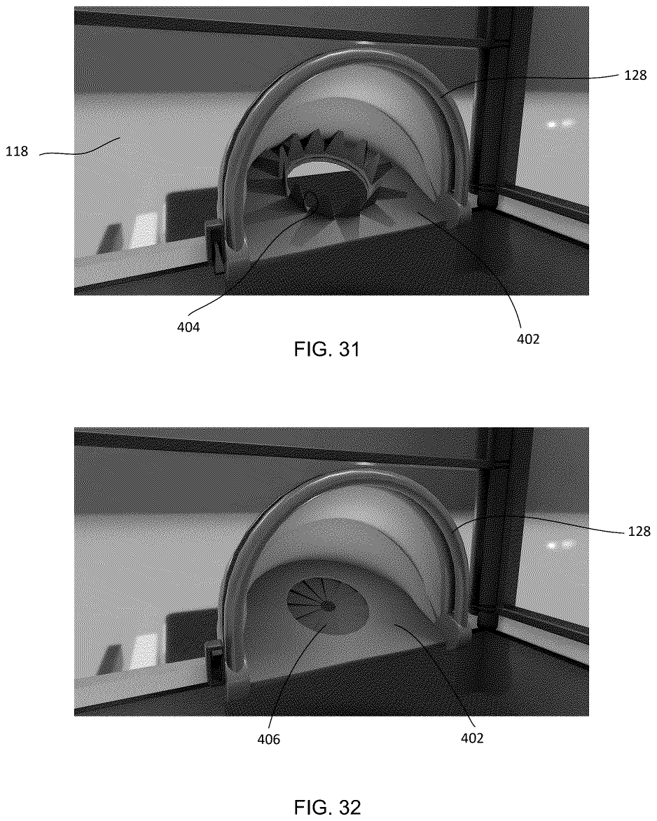

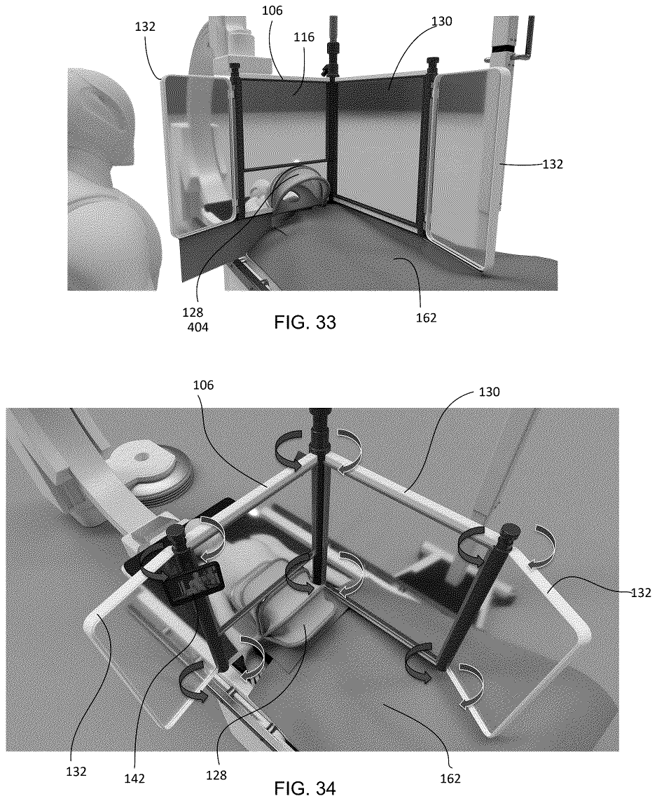

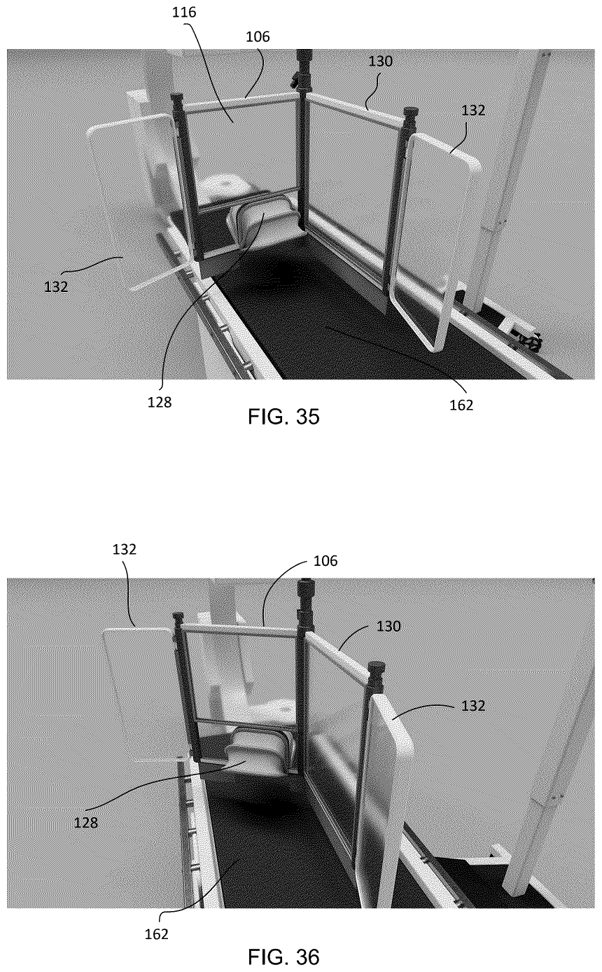

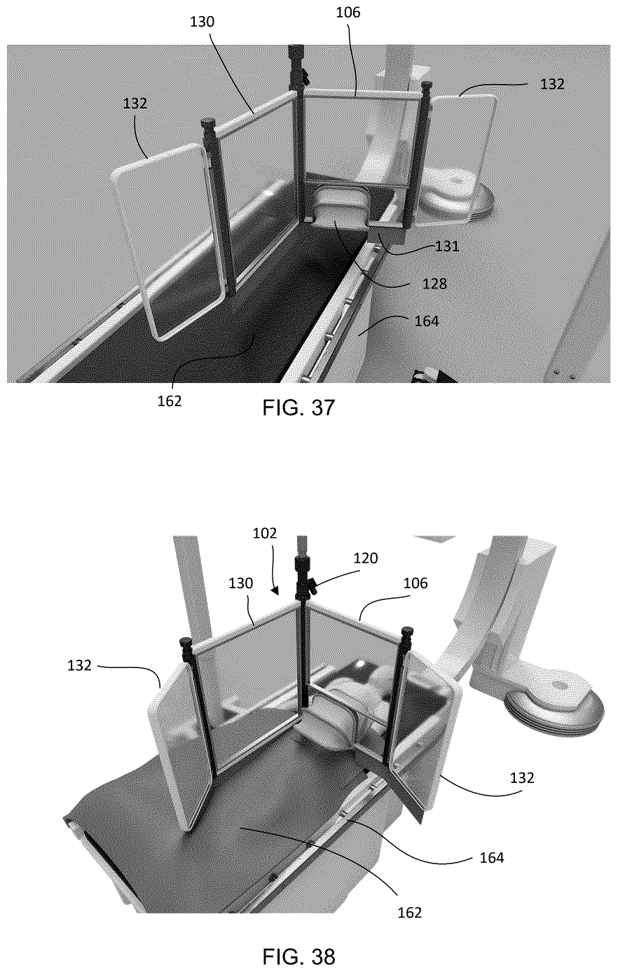

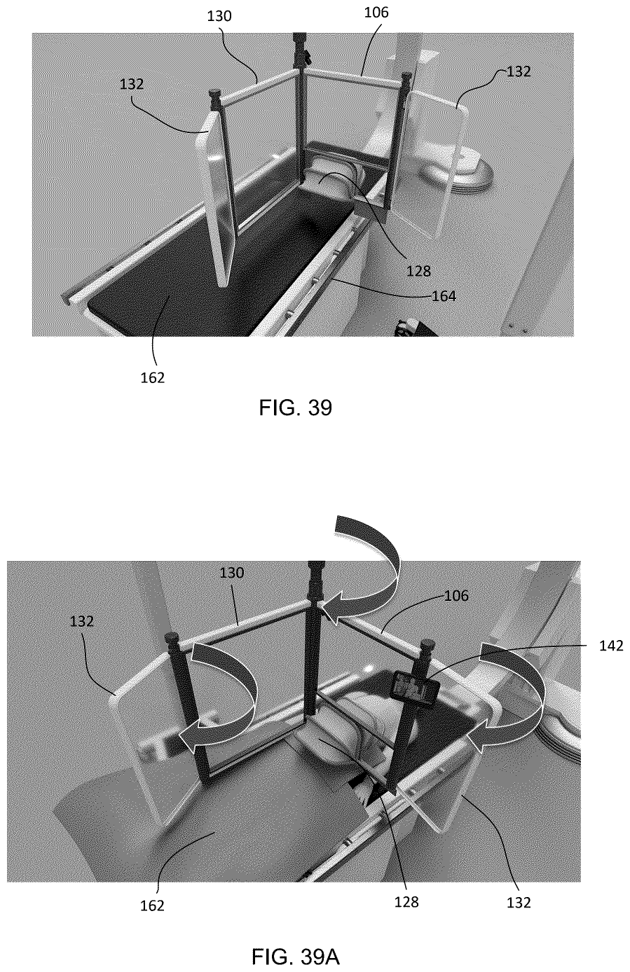

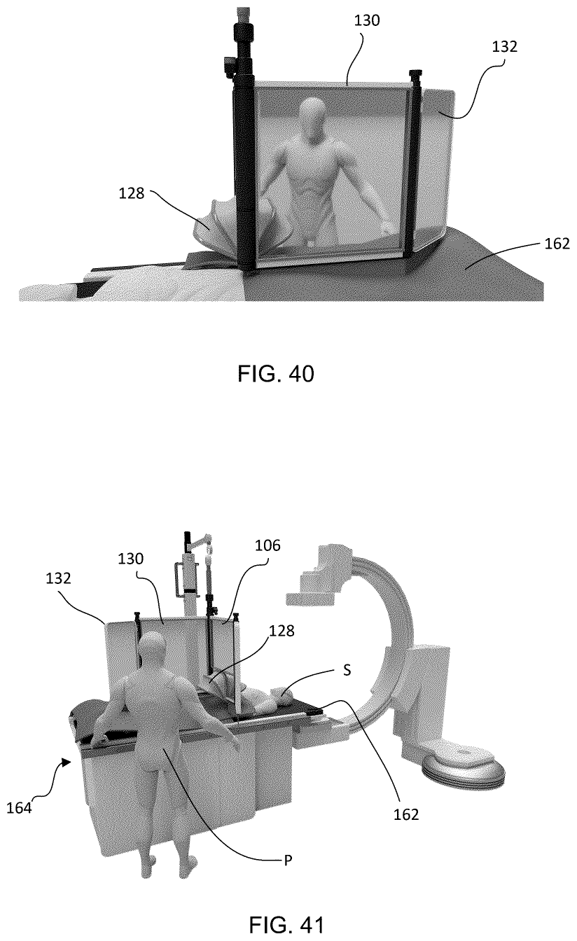

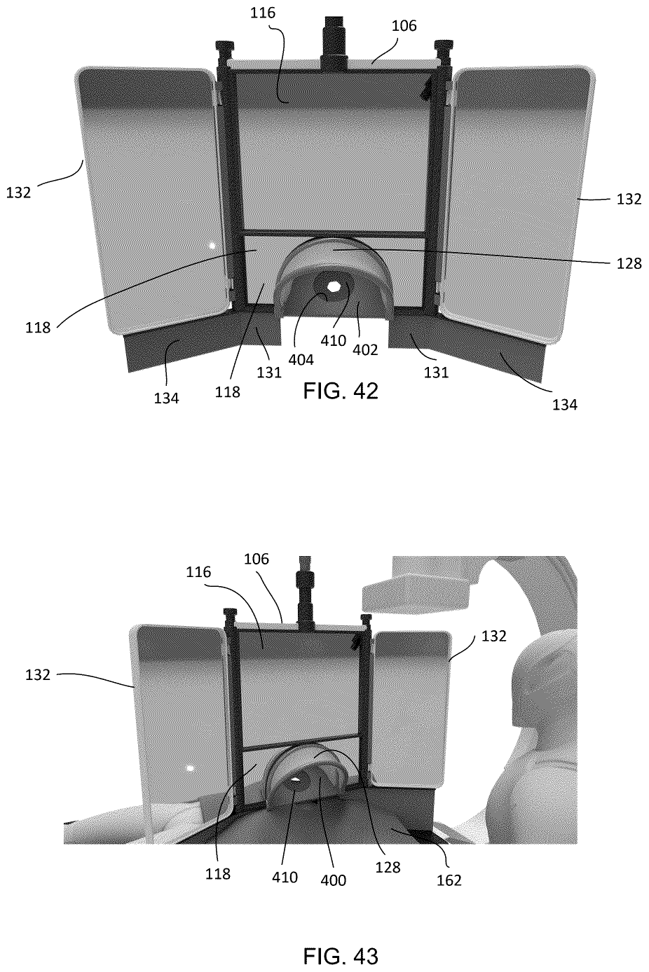

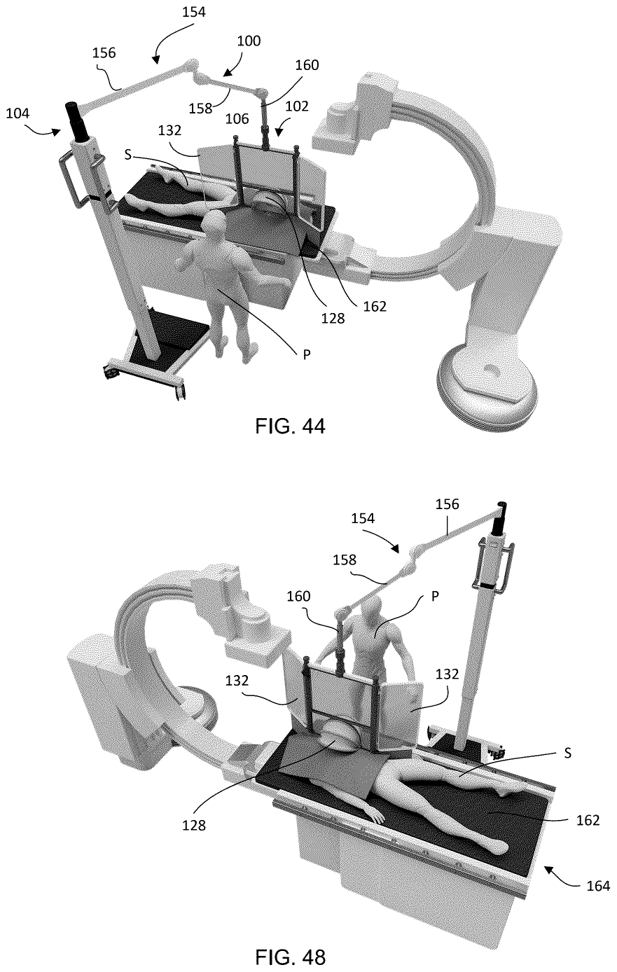

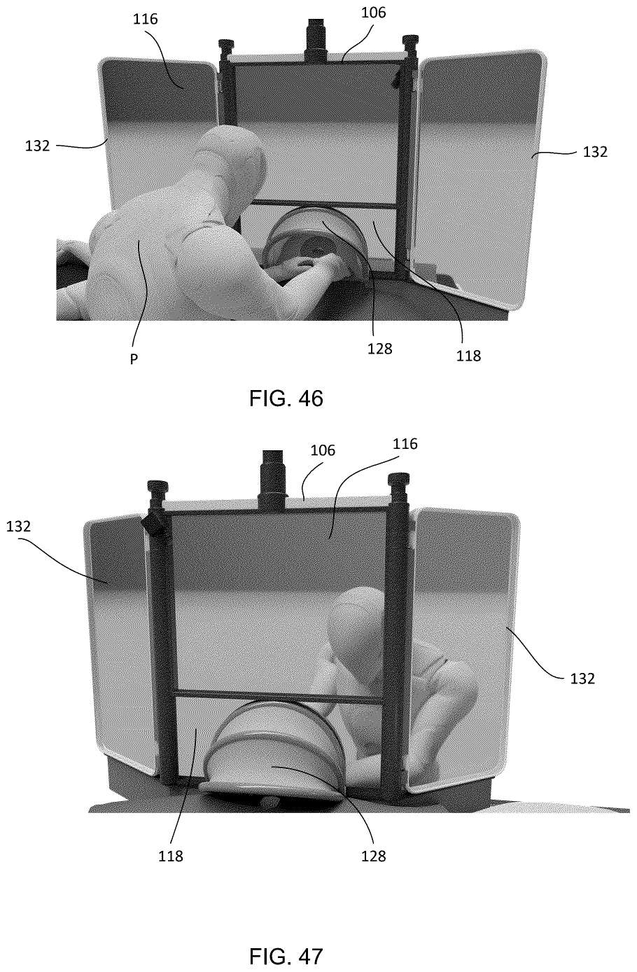

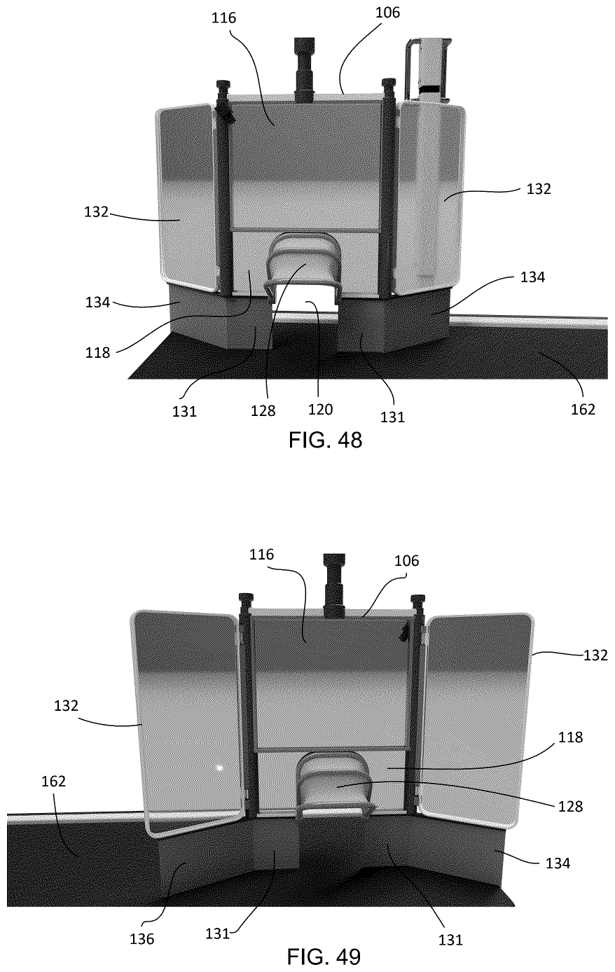

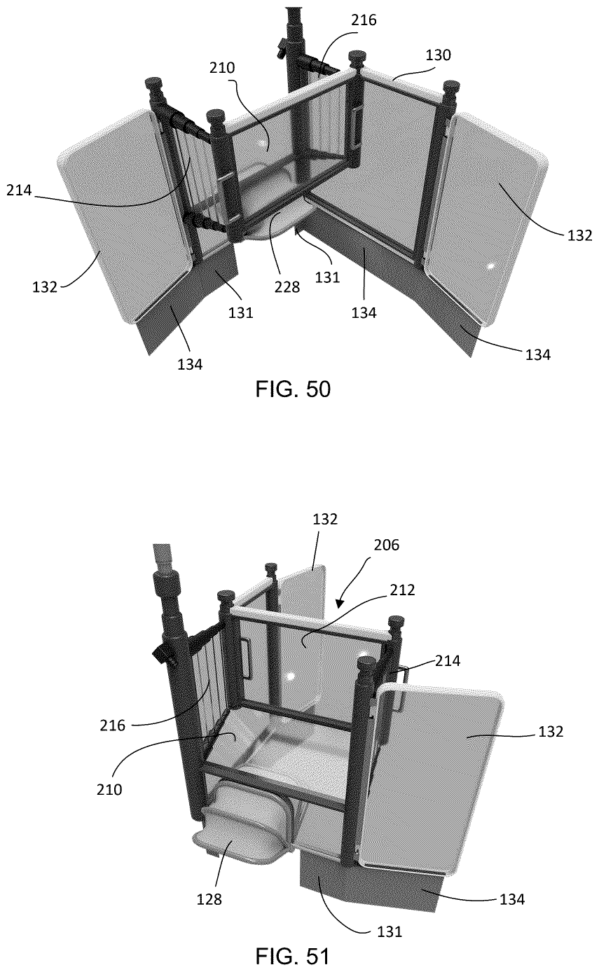

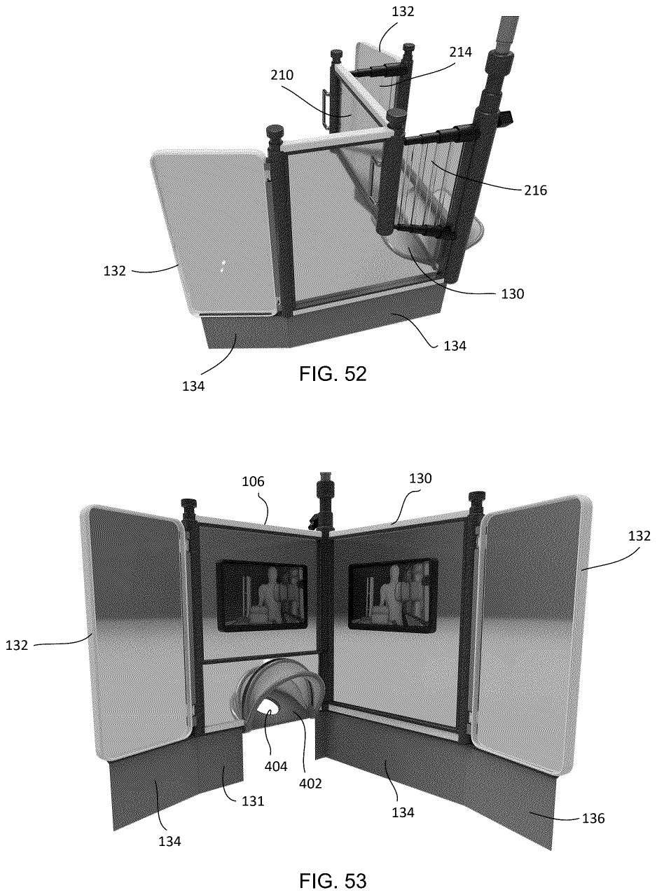

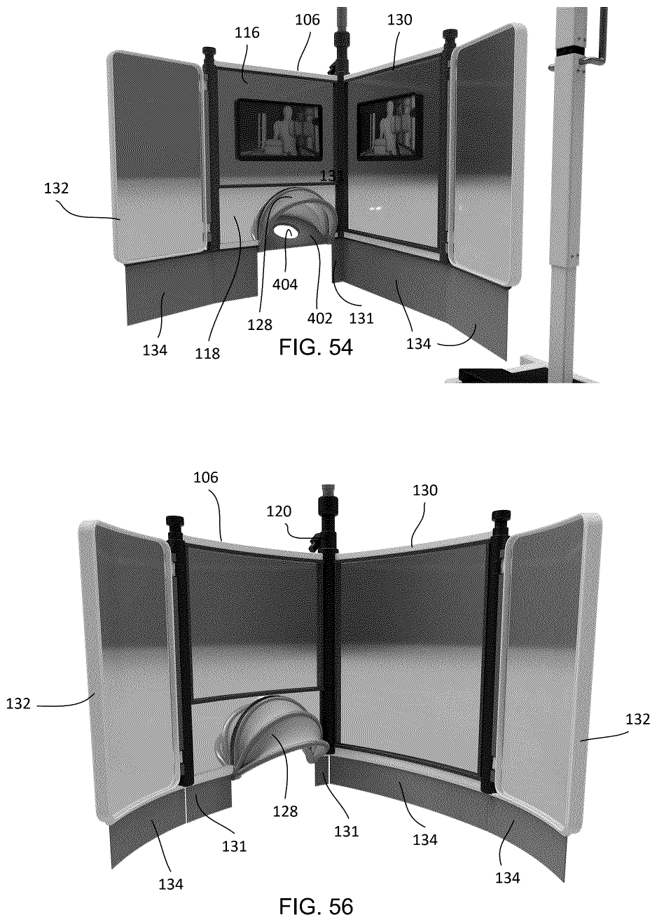

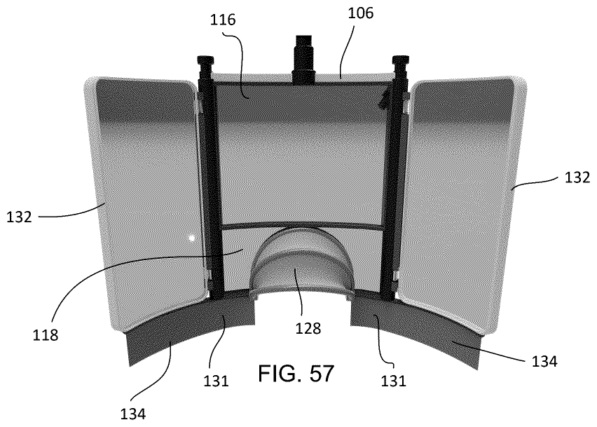

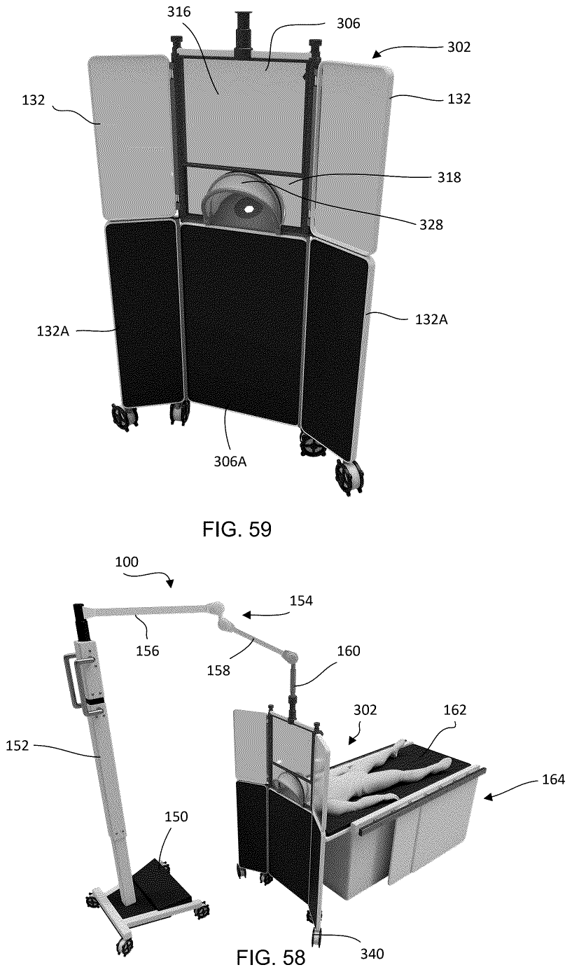

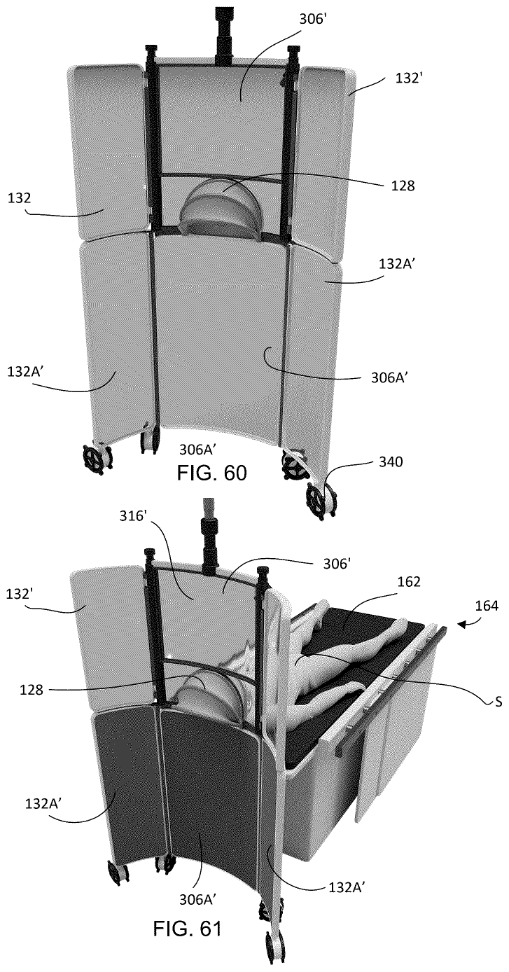

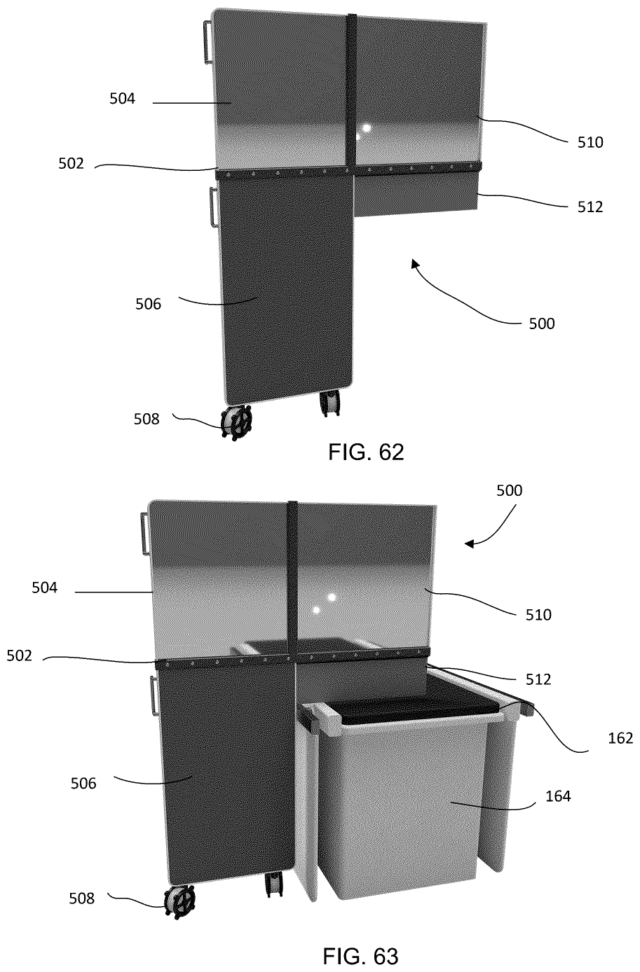

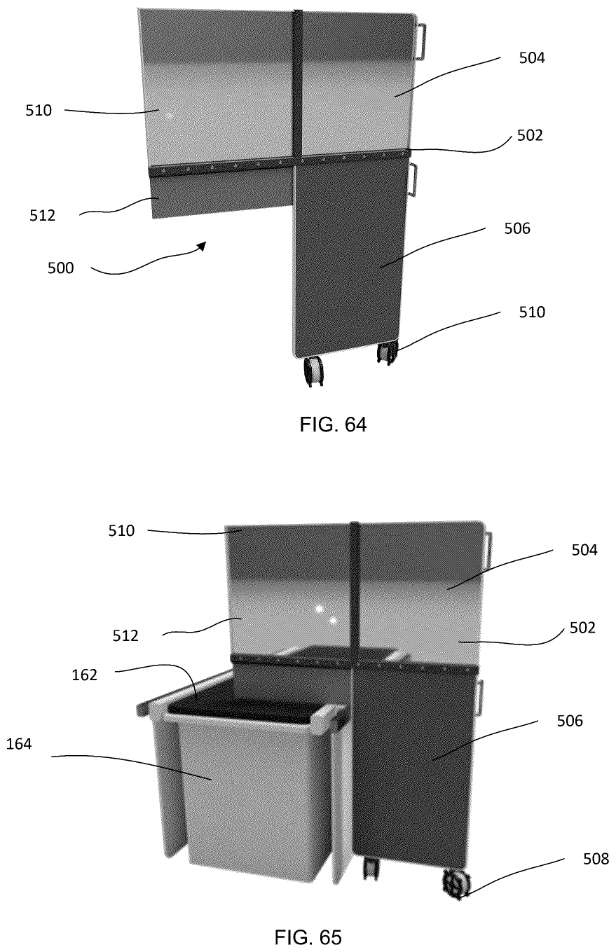

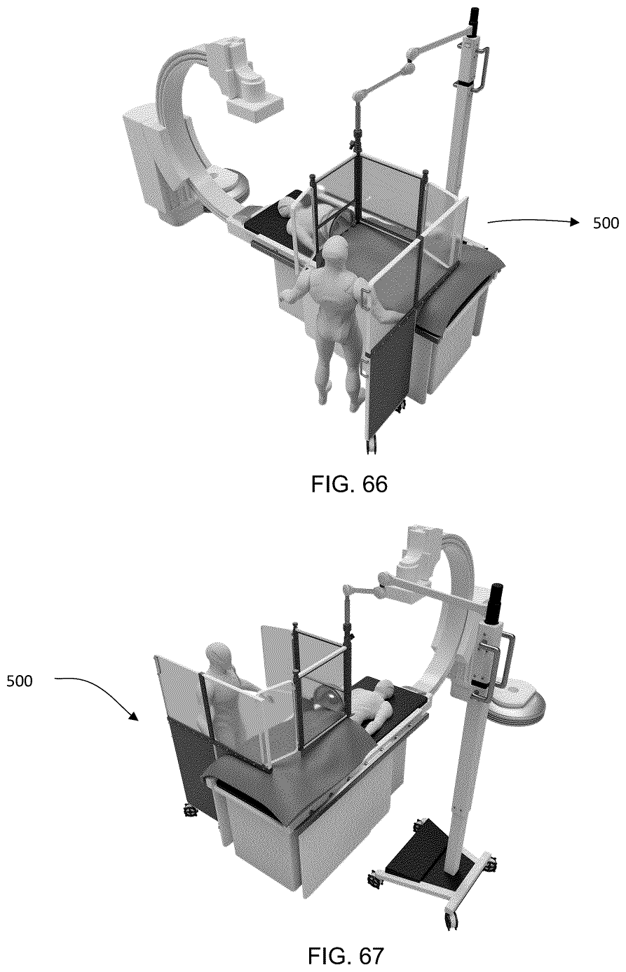

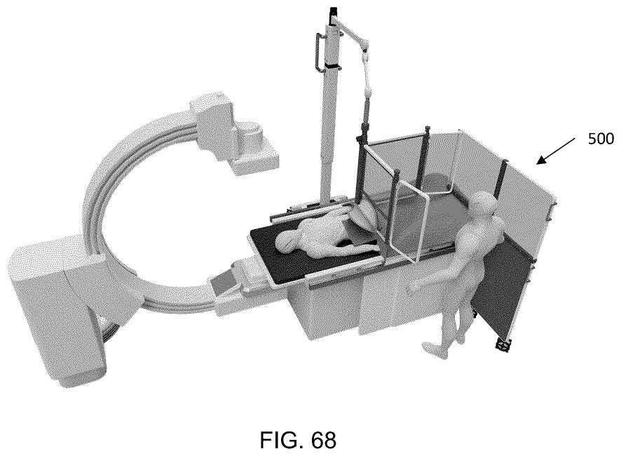

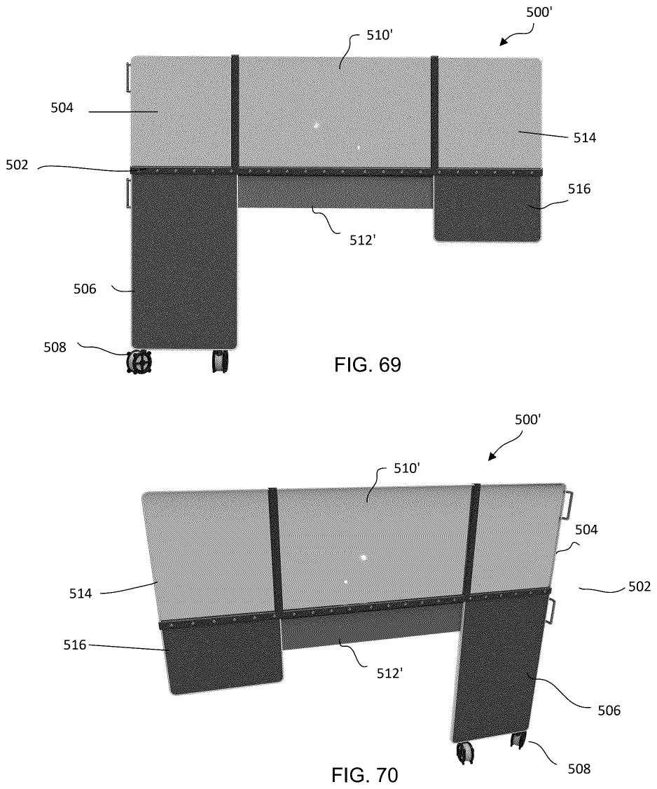

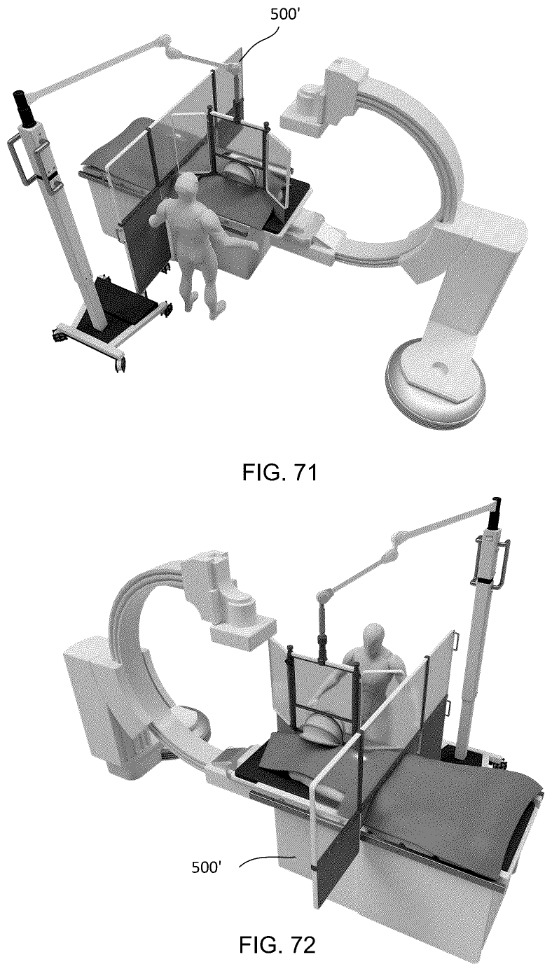

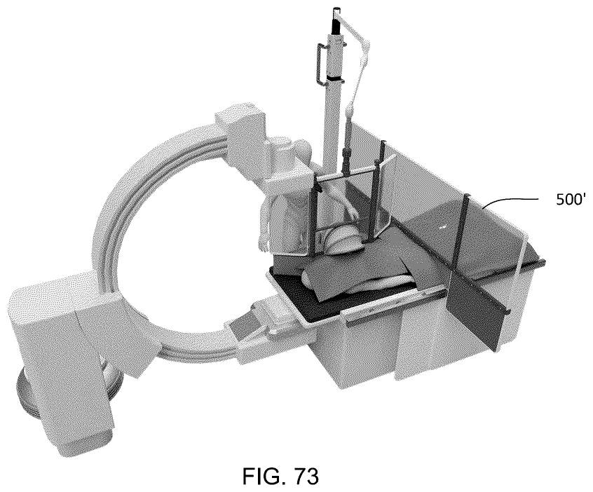

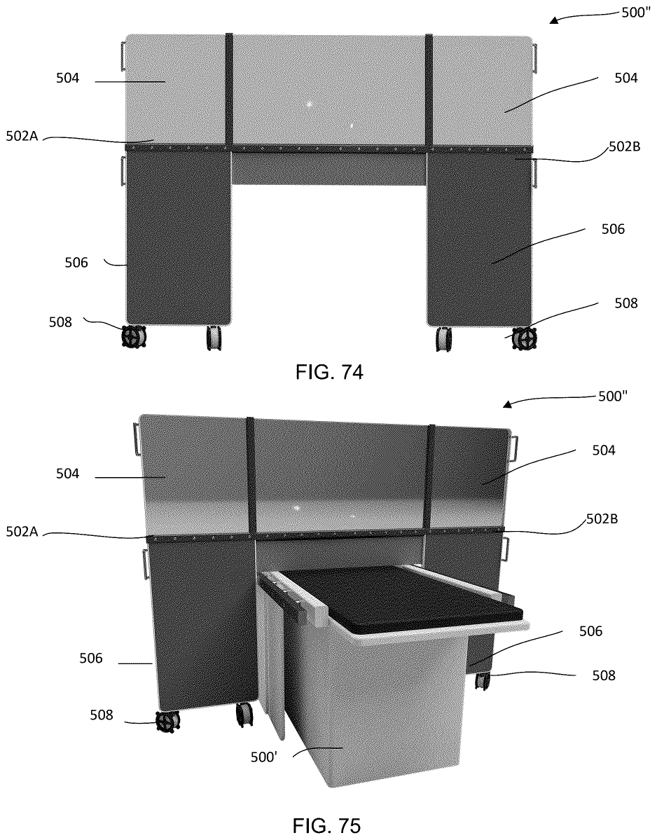

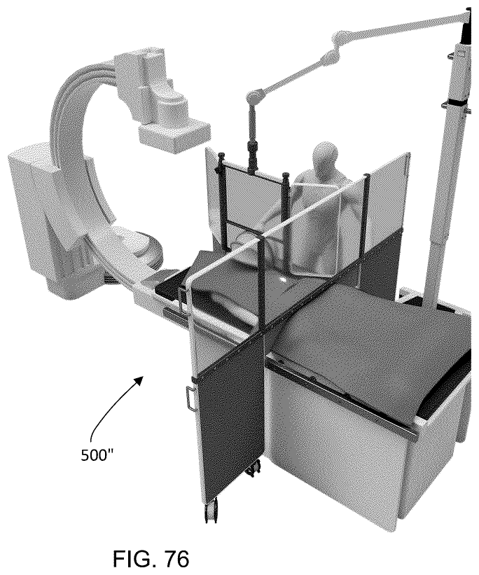

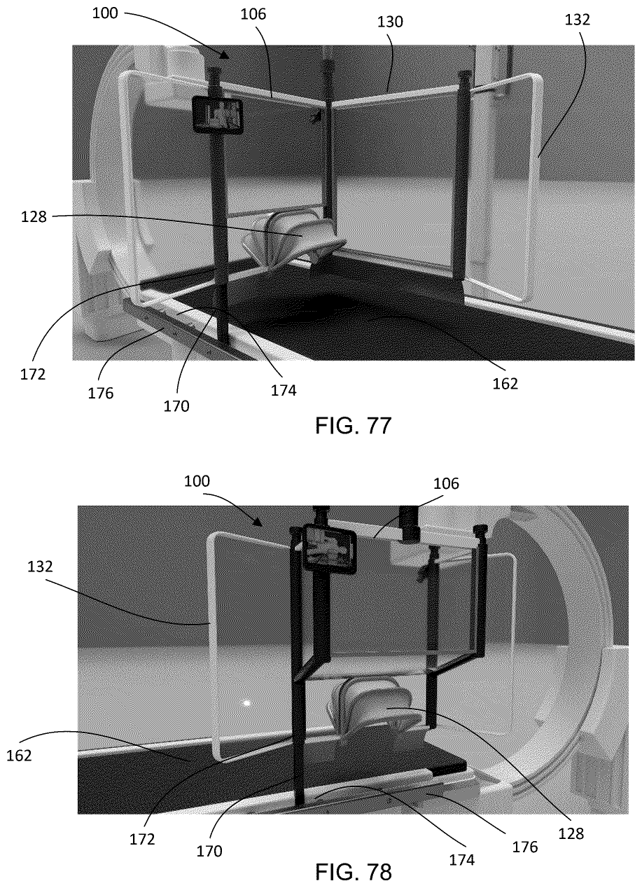

As shown in FIGS. 20-25, an comprises a radiopaque panel 402 with an opening 404, is provided in the canopy 128. The panel 402 restricts radiation from passing through the primary panel 106 via the opening 120, while opening 404 in the panel 402 provides access to the subject. As shown in FIGS. 26-27, the opening 404 can be provided with an iris device 406 for selectively adjusting the size of the opening through the panel 402. As shown in FIGS. 28-30 the opening 404 can alternatively be provided with a plurality of overlapping petals 408 that further restrict the opening, but can be deflected to provide a wider passage as needed. As shown in FIGS. 42 and 43, the aperture closure device 400 can include an adjustable iris device 410 for selectively adjusting the size of the opening through the panel 402 to provide the minimum access required, while reducing the passage of radiation as much as reasonably possible.

The primary panels, the secondary panels, and the wing panels are preferably made of transparent radiation-resistant leaded glass or acrylic. Of course, portions of some or all of these panels can be made translucent or opaque if desired. The shield 300 is particularly adapted to provide protection to the medical professionals Cath Lab Allied Health personnel (e.g., echocardiographer and anesthetist), who typically work at the head of the table to provide patient care (anesthetist) and imaging assistance (e.g., echocardiographer) to interventionist during the procedure. This working position is near the X-Ray tube and generally not well protected from radiation exposure. Mobile shields and traditional personal lead apparel are commonly employed yet despite these measures, clinical research documents these individuals are still exposed to excessive and disproportionate radiation. The shield 300 can be applied to improve protection for these individuals. The shield 300 consists of both upper components (panels 306 and 132) and the lower components (panels 306A and 132A), on wheels to achieve mobility (alternatively or additionally suspended from a support arm connected to floor pedestal or ceiling mount).

The panels 306A and 132A adjustable angulation radiation resistant panels, which can be adjusted for angulations relative to each other. These lower panels may be constructed of radiopaque soft leaded drape material or leaded acrylic or glass. The shield 300 can be mounted on wheels 340 such that the shield is mobile and can be moved easily or locked into position. The shield 300 and specifically the lower part of the shield is height adjustable to accommodate the positioning of the shield relative to the height of the procedure table 164, the specific height to be adjusted by the medical professional. This height adjustment can be accomplished by several mechanisms including, for example, via pneumatic telescoping tubes in the vertical connecting segments that connect the panels; other similar mechanisms for height adjustment are known in the field.

The upper shield members 106 and 132 preferably can also be rotated independent of and relative to the lower shield members 132A, such that dual swinging hinges allow the upper panels to be angulated and adjusted according to preference, without moving the position of the lower panels.

The panel 306 includes dual canopies 328 with an adjustable aperture closure device with an iris forming an adjustable opening, or petalled design, described above. (Canopy IRIS™/Canopy FLOWER-PETAL™). The design of the adjustable aperture closure device is separately described.

The opening 320 in panel 306 and the canopies 328 cooperate to provide shield access to the subject patient for instrumentation. For example, for an echocardiographer, this opening allows passage and manipulation of an echocardiographic (ultrasound) probe that is typically placed through the patients mouth into the esophagus and typically requires positionable manipulation during the procedure such that the echocardiographers hands require access to the probe at times at or near the aperture. Similarly, for an anesthesiologist, the opening 320 allows access to place and manage a breathing tube into the subject's mouth (or nose) and may be required to make needed adjustments during the procedure.

Any of the shields, but particularly shield 300 can be provided with a two-way microphone/audio system such that the Echocardiographer and Anesthesia individuals can easily communicate with the operating team. This audio system can be located at the side or top edge of the shield to allow communication but not create a radiation gap.

The shield can be equipped with an optional chair for the Echocardiographer and Anesthesia personnel to sit during the procedure. This may consist of a flip-down seat with cushions that can be positioned closed flat against the shield when not in use, or easily “flipped down” for use.

The shields and in particular shield 300 can be equipped with an option for an internal flip down “desk-top” to accommodate writing on papers or working on a computer laptop, etc. This may be positioned closed flat against the shield when not in use, or easily “flipped down” for use.

The example method is described as performed by a medical professional in which radiation is applied to a subject on a procedure table, more generally. Nonetheless, it should be understood that the method described herein are not limited to the radiation shield 100, 200, or 300. Likewise, the radiation shields 100, 200, and 300 herein should not be understood to be limited to the method.

At the outset, it should be appreciated that the medical professional has decided to use a radiation source 210 on the subject for a procedure involving the application of radiation to a subject, such as a radiation treatment procedure, or a radiologic guided medical procedure. Generally, the operator is a trained medical professional trained to use the radiation source 210, such as a x-ray imaging system mounted on a C-arm.

The shields are useful for procedures involving peripheral vascular from leg, electrophysiology (e.g. pacers and defibrillator placement) from the shoulder, and surgical procedures employing fluoroscopy (e.g., urological or orthopedic procedures) and other radiology type procedures (e.g. pain management or in-neck catheter placement in neck).

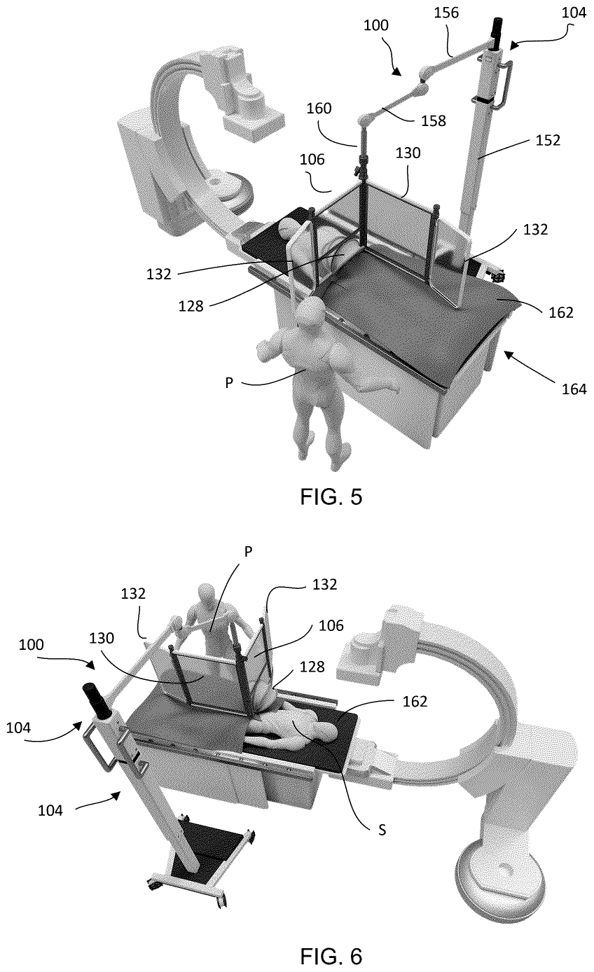

Initially, the subject S is positioned on the surface 162 of the procedure table 164. As shown in FIGS. 4-5 and 11 medical processional P positions the screen 102 of the shield 100 transversely across the procedure table 164, with a portion (the torso) of the subject S received in the opening 120. The medical professional deploys the canopies on the primary panel 106, one on the forward side of the screen 102 that helps block radiation from passing through the opening 120, and one on the rear side of the screen, that helps block radiation that does pass through the opening 120. The medical professional positions the secondary panel 130 on the opposition side of the procedure table 130, and adjusts the wing panel 132 on the secondary panel, and the wing panel on the primary panel 106. The flaps 131 and 134 block radiation from passing between the bottom of the screen 102 and the surface 162 of procedure table 164.

Thus protected behind the shield 100 from the radiation emanating from the x-ray imaging system on the C-arm, the medical professional can conduct the procedure accessing the subject S under the canopy 128 to introduce a medical device such as a catheter into the subject S, and conduct the procedure with real time imaging from the x-ray imaging system on the other side of the shield.

Similarly, as shown in FIGS. 6 and 14 the screen 102 is positioned partially transversely across the procedure table 164 and partially across a subject S on the surface 162 of the procedure table. As shown in FIG. 6, a portion of the subject S (the arm) extends through the opening 120. Again, the canopies 128 are deployed to block radiation from passing through the opening 120. FIG. 6 shows a possible set up for a catheterization with a radial approach via the subject's arm. The health care professional can access the subject's arm under the 128.

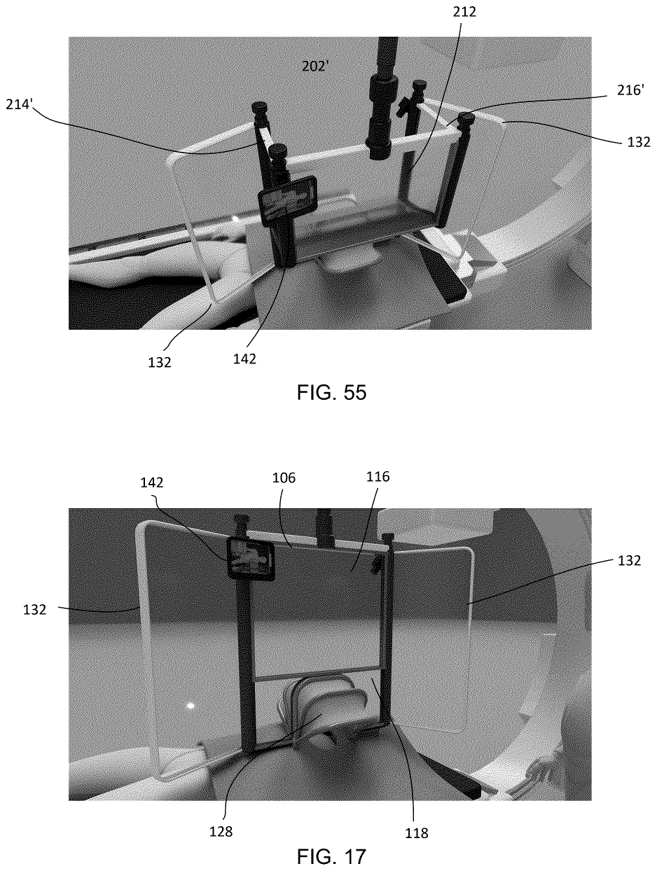

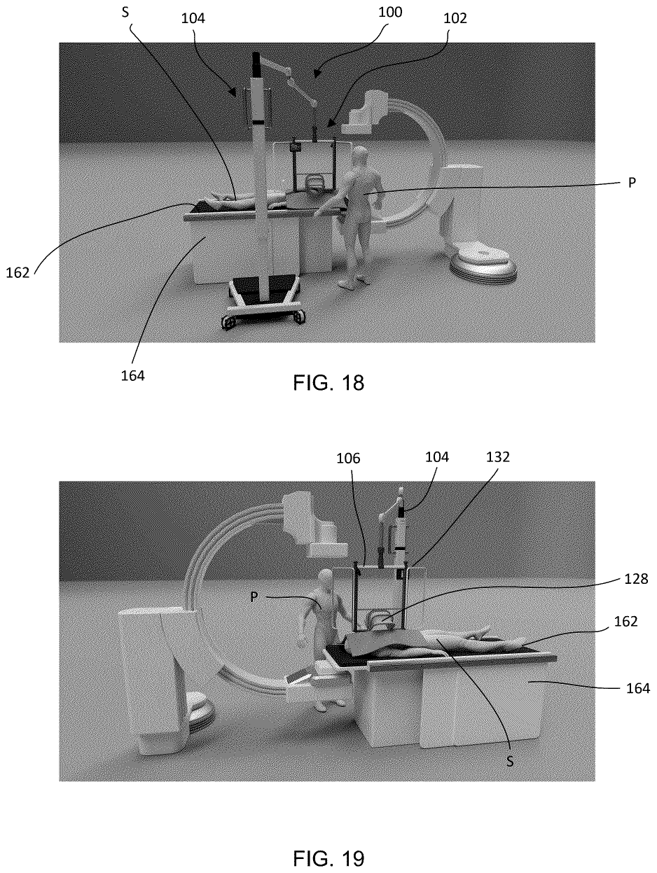

As shown in FIGS. 17-19 and 38-39 the screen 102 is positioned transversely across a subject S on the surface 162 of the procedure table 164. As shown in the FIGURES, the screen 102 extends longitudinally along the procedure table 164, with a portion of the subject S (the arm and shoulder) extends through the opening 120. This version of the screen simply has a primary panel 106 and wing panels 132. The canopies 128 block radiation for entering or leaving from opening 120, and the canopy 128 provides a space for the Medical Professional P to access the patient.

As shown in FIG. 34 and 44-49, the primary panel 106, the secondary panel 130, and the wing panels 132 are preferably all hingedly connected to allow the panels to be pivoted relatively to each other to effectively shield the medial personnel tending the subject, and accommodate their movement around the subject on the procedure table 164.

As shown in FIG. 58-61 a shield 300 can be manipulated to a position adjacent a subject S on the surface 162 of a procedure table. The screen 302 is particularly adapted to be positioned adjacent the Subject S, for example for use by echocardiographer and anesthetist. The screen 302 has an opening for receiving a portion of the Subject S, such as the Subject's head. The canopies 318 block radiation and provide a space for the echocardiographer, anesthetist, or other medical professional to work.

The screen 302 is suspended with support 104, so that it can be quickly moved into and out of place. The canopies of the screens any of the shields can include a for each of the canopies can have an aperture closure device to block radiation, and in particular scattered radiation, from passing through the canopies to medical personnel behind the shield. An opening, which can be adjustable, allows for necessary access to the subject, for example to introduce and navigate a medical device. Special soft, flexible, radiation resistant pads that have openings and cut outs to accommodate the medical devices being used, and reduce radiation being transferred from the subject to the surrounding medical personnel can be provided. These pads can be provided with drapes as well.

A companion shield, useful with the shields of this disclosure, is indicated generally s 500 in FIGS. 62-65. The companion shield 500 comprises a vertically oriented main panel 502 of a radiopaque material. The panel 502 preferably extends from adjacent the floor to a height of a standing medical professional. The upper portion 504 of the main panel 502 can be transparent so that a medical professional behind the companion shield 500 can see through the panel 502. The lower portion 506 of the panel 502 can be transparent or opaque. The main panel 502 have wheels 508 to facilitate positioning the shield 500 within the procedure room. A radiopaque auxiliary panel 510 extends from one side of the upper portion 504 of the panel 502, and is sized and positioned to extend over the procedure table 164. The auxiliary panel 510 had a flexible radiopaque flap 512 for blocking radiation between the bottom of the auxiliary panel 510 and the surface 162 of the procedure table 164.

As shown in FIG. 63, the companion shield 500 is adapted to be positioned adjacent a procedure table 164, with the main panel 502 shielding the space to the side of the table, and the auxiliary panel 510 and its flap 512 extending over the surface 162 of the table, shielding the space over the table. When used in conjunction with one of the shields of this disclosure, the medical professionals can be effectively enclosed in shields that can be readily adjusted and repositioned as needed.

As shown in FIGS. 64 and 65, the companion shield 500 can be reversed so that it can be deployed on the right side of procedure table as necessary. As shown in FIGS. 66-68, the companion shield 500 can be used in conjunction with one of the shields of this disclosure, such as shield 100 to enclose the medical personnel, and shield them from radiation, such as from x-ray imaging equipment mounted on a C-arm.

A first alternate construction of the companion shield is indicated as 500′ in FIGS. 69-70. Companion shield 500′ is similar in construction to companion shield 500 and corresponding parts are identified with corresponding reference numerals. Companion shield 500′ comprises a vertically oriented main panel 502 of a radiopaque material. The panel 502 preferably extends from adjacent the floor to a height of a standing medical professional. The upper portion 504 of the main panel 502 can be transparent so that a medical professional behind the companion shield 500 can see through the panel 502. The lower portion 506 of the panel 502 can be transparent or opaque. The main panel 502 have wheels 508 to facilitate positioning the shield 500′ within the procedure room. A radiopaque auxiliary panel 510′ extends from one side of the upper portion 504 of the panel 502, and is sized and positioned to extend entirely across the procedure table 164. The auxiliary panel 510′ had a flexible radiopaque flap 512′ for blocking radiation between the bottom of the auxiliary panel 510 and the surface 162 of the procedure table 164.

The companion shield 510′ also includes a secondary auxiliary panel 514, which has a depending extension 516, which can either be a rigid panel or a flap similar to flap 512′.

As shown in FIGS. 71-73, the companion shield of this first alternate construction can be positioned adjacent a procedure table, with the main panel 502 shielding the space along the side of the table. Auxiliary panel 510′ and flap 512′ shields the space over the procedure table, and secondary auxiliary panel 514, and extension 516 shield the space on the opposite side of the procedure table.

A second alternate construction of the companion shield is indicated generally as 500″ in FIGS. 74-76. Companion shield 500″ is similar in construction to companion shield 500 and corresponding parts are identified with corresponding reference numerals. Companion shield 500″ comprises first and second vertically oriented main panels 502A and 502B of a radiopaque material. The panels 502A, 502B preferably extend from adjacent the floor to a height of a standing medical professional. The upper portions 504 of the main panels 502A, 502B can be transparent so that a medical professional behind the companion shield 500″ can see through the panels 502A, 502B. The lower portions 506 of the panels 502A, 502B can be transparent or opaque. The main panels 502A, 502B have wheels 508 to facilitate positioning the shield 500″ within the procedure room. A radiopaque auxiliary panel 510′ extends between the upper portions 504 of the panels 502A and 502B, and is sized and positioned to extend entirely across the procedure table 164. The auxiliary panel 510′ has a flexible radiopaque flap 512′ for blocking radiation between the bottom of the auxiliary panel 510′ and the surface 162 of the procedure table 164, as shown in FIG. 75.

The companion shield 502″ can be deployed in conduction with one of the shields of this disclosure, such as shield 100, at the side of a medical professional to substantially enclose the medical professional.

As shown in FIGS. 77-78, the shield 100 can include a telescoping anchor bar 170 configured to selectively secure the shield in a fixed position relative to the procedure table 164. The anchor bar 170 is mounted within the lower portion of a wing panel 132 and is extendable from a stowed position, in which the anchor bar 170 is retracted into a housing 172 within the frame of the wing panel 132, to a deployed position, in which the anchor bar 170 telescopes downward to engage with an opening 174 around the periphery of the procedure table. In this preferred embodiment the openings 174 are formed by a rail 176 mounted to the sides of the procedure table 164. The rail 176 may be a metal track or guide spaced from the lateral edge of the procedure table 164 defining a plurality of spaced openings 174 configured to receive the distal end of the anchor bar 170.

When the anchor bar 170 is received within one of the openings 174, the shield 100 is secured against lateral and possibly also rotational movement relative to the procedure table 164. The telescoping anchor bar 170 may include one or more nested tubular segments that lock in the extended position using a spring-loaded detent, twist-lock collar, or other mechanism. The anchor bar 170 may be deployed manually, for example, by a user operating a handle or by grasping and pulling the distal end of the anchor bar 170 to move it into the deployed position, or it can be operated mechanically, pneumatically, or hydraulically. When retracted to the stowed position, the anchor bar 170 can be generally flush within the wing panel 132, allowing for unimpeded repositioning or transport of the shield 100.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A radiation shield adapted to be disposed across a portion of a subject supported on the surface of a procedure table to protect medical professionals working on one side of the shield from radiation being applied to the subject on the other side of the shield, the shield comprising:
a first generally vertically oriented radiopaque panel positionable generally transversely across a procedure table, the first panel having a lower edge with a recess having an upper edge and side edges forming an opening for accommodating a portion of a subject's body;
at least one radiopaque collapsible canopy system, around the top and sides of the recess, and deployable downwardly to block radiation in the space between the subject and the top and sides of the recess; and
radiopaque flaps depending down from the lower edge of the first panel on either side of the recess for blocking radiation between the lower edge of the first panel and the top of the procedure table.

2. The radiation shield according to claim 1 wherein the first panel has left and right side edges, and further comprising a second generally vertically oriented radiopaque panel, extending from the right side edge of the first panel.

3. The radiation shield according to claim 2 wherein the second panel is pivotally mounted at the right side edge of the first panel.

4. The radiation shield according to claim 2 wherein the second panel is fixedly mounted at the right side edge of the first panel, and extends generally perpendicularly to the first panel.

5. The radiation shield according to claim 2, wherein at least portions of the first and second panels are transparent to visible light.

6. The radiation shield according to claim 2 further comprising a radiopaque wing panel pivotally mounted at the side edge of the second panel opposite from the side edge adjacent the first panel.

7. The radiation shield according to claim 6 wherein the wing panel is extensible to increase or decrease its width.

8. The radiation shield according to claim 1 further comprising a radiopaque wing panel pivotally mounted at the left side edge of the first panel.

9. The radiation shield according to claim 8 wherein the wing panel is extensible to increase or decrease its width.

10. The radiation shield according to claim 1 wherein the first panel has an opening above the top edge of the recess, the opening having a bottom edge, and left and right side edges, and further comprising a window having a bottom edge, and left and right side edges, and extensible radiopaque panels between the bottom, left and right side edges of the window and the bottom, left and right side edges of the opening, respectively, so that the window can translate rearwardly relative the remainder of the first panel to accommodate rearward the movement of imaging equipment on forward side of the first panel.

11. The radiation shield according to claim 1, wherein the first panel has forward and rearward faces, and wherein there is a radiopaque collapsible canopy system on each face.

12. The radiation shield according to claim 1, further comprising a mounting system for suspending the first panel transversely over the procedure table.

13. The radiation shield according to claim 1, wherein a window is extendable rearward, and is tiltable out of a plane parallel the remainder of the first panel.

14. The radiation shield of claim 1, further comprising at least one video monitor mounted thereon.

15. A system including the radiation shield of claim 1, further comprising:
a radiation source positioned on one side of the first panel;
a camera positioned on the same side as the radiation source;
a support including a base and a mounting arm coupled to the first panel; and
at least one video monitor integrated into the first panel for displaying an output from the camera.

16. A method of protecting an operator during a procedure in which radiation is applied to a subject on a procedure table, the method comprising:
positioning a radiation shield having a first generally vertically oriented radiopaque panel generally transversely across a portion of a subject on a procedure table and the subject thereon, between a radiation source and an operator, the first panel having a lower edge with a recess having an upper edge and side edges forming an opening for accommodating a portion of a subject's body; and
operating at least one radiopaque collapsible canopy system to block radiation in the space between the subject and the top and sides of the recess.

17. The method of claim 16 wherein the first panel has forward and rearward faces, and wherein there is a radiopaque collapsible canopy system on each face, and wherein the method further comprises operating both one radiopaque collapsible canopy systems to block radiation in the space between the subject and the top and sides of the recess.

18. The method of claim 16 wherein the first panel has a radiopaque wing panel pivotally mounted at a side edge of the first panel, and wherein the method further comprises adjusting the angular orientation of the wing panel to shield the operator from radiation.

19. The method of claim 16 wherein the first panel has a radiopaque wing panel mounted at a side edge of the first panel, that is extensible to increase or decrease its width and wherein the method further comprises adjusting the width of the wing panel to shield the operator from radiation.

20. The method of claim 16 wherein first panel has an opening above the top edge of the recess, the opening having a bottom edge, and left and right side edges, and further comprising a window having a bottom edge, and left and right side edges, and extensible radiopaque panels between the bottom, left and right side edges of the window and the bottom, left and right side edges of the opening, respectively, and moving the window to accommodate rearward the movement of imaging equipment on forward side of the first panel.
